(19) United States
(12) Patent Application Publication
(10) Pub. No.: US 2026/0327461 A1
(43) Pub. Date: Oct. 22, 2026

(54) Waterborne Pressure Sensitive Adhesive Composition with Polymodal Particle Size Distribution

(71) Applicants: Dow Globa Technologies LLC, Midland, MI (US); Rohm and Haas Company, Collegeville, PA (US)

(72) Inventors: Joseph B. Binder, Collegeville, PA (US); Saswaitt Pujari, Collegeville, PA (US); Kylie B. Manning, Collegeville, PA (US)

(21) Appl. No.: 19/725,902

(22) Filed: Jun. 30, 2026

Related U.S. Application Data
(63) Continuation of application No. 18/254,598, filed on Dec. 20, 2021.
(60) Provisional application No. 63/128,734, filed on Dec. 21, 2020.

(51) Int. Cl. C09J 7/38

(52) U.S. Cl. CPC C09J 7/385; C09J 2301/408; C09J 2301/414; C09J 2433/00

(57) ABSTRACT

The present disclosure is directed to a water-based adhesive composition. In an embodiment, the water-based pressure-sensitive adhesive composition includes a plurality of particles having a polymodal particle size distribution. The particles are composed of (A) a first polymer, and (B) a second polymer different than the first polymer. The particles have a d₅₀ greater than 450 nm and a polydispersity index, PDi, from 0.5 to 2.0. (C) The composition has a solids content greater than or equal to 65.5 wt %. Further disclosed are articles with the water-based pressure-sensitive adhesive composition.

### BACKGROUND

A pressure sensitive adhesive (“PSA”) is an adhesive that bonds with an adherent when pressure is applied to it. PSAs differ from adhesives that are activated by heat, irradiation, or a chemical reaction, for example. Typically, a waterborne PSA is applied to a substrate as an emulsion or as a dispersion, which is then dried to remove the liquid carrier.

A pressure sensitive adhesive is typically characterized by its adhesion and its cohesion. Adhesion, is exhibited by a PSA's peel strength and/or tack to the substrate. Cohesion is exhibited by a PSA's shear resistance. An inverse relationship exists between adhesion and cohesion whereby a PSA with high adhesion has low cohesion, and a PSA with low adhesion has high cohesion.

For coating technologies such as curtain coating for example, it is desirable to employ waterborne acrylic-based pressure sensitive adhesive dispersions with a solids content greater than 65 wt % in order to (i) decrease transportation costs, (ii) improve coating rheology, and (iii) minimize drying energy. However, as the solids content in the waterborne PSA composition increases, so too does viscosity of the PSA increase. As the solids content in the waterborne PSA composition increases, the risk of coagulation of the polymer particles increases as well. Bittiness in the resultant PSA dry layer also increases with increased solids content.

Consequently, the art recognizes the need for a waterborne acrylic-based pressure sensitive adhesive composition having greater than 65 wt % solids content and a low viscosity.

### SUMMARY

The present disclosure is directed to a water-based adhesive composition. In an embodiment, the water-based pressure-sensitive adhesive composition includes a plurality of particles having a polymodal particle size distribution. The particles are composed of (A) a first polymer, and (B) a second polymer different than the first polymer. The particles have a d₅₀ greater than 450 nm and a polydispersity index, PDi, from 0.5 to 2.0. (C) The composition has a solids content greater than or equal to 65.5 wt %.

The present disclosure provides an article. In an embodiment, the article includes a first substrate, and a layer of a dried water-based pressure-sensitive adhesive composition on the first substrate. The water-based pressure-sensitive adhesive composition includes a plurality of particles having a polymodal particle size distribution. The particles are composed of (A) a first polymer, and (B) a second polymer different than the first polymer. The particles have a d₅₀ greater than 450 nm and a polydispersity index, PDi, from 0.5 to 2.0. (C) The composition has a solids content greater than or equal to 65.5 wt %.

### DESCRIPTION OF THE DRAWINGS

FIG. 1 is a graph showing particle size distribution for the water-based pressure-sensitive adhesive composition of comparative sample 1.

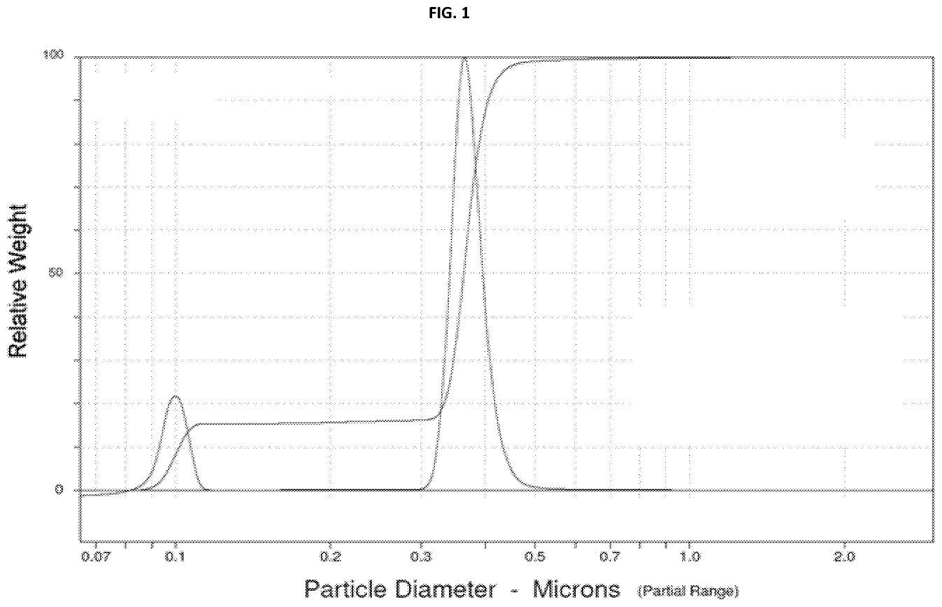

FIG. 2 is a graph showing particle size distribution for the water-based pressure-sensitive adhesive composition of comparative sample 2.

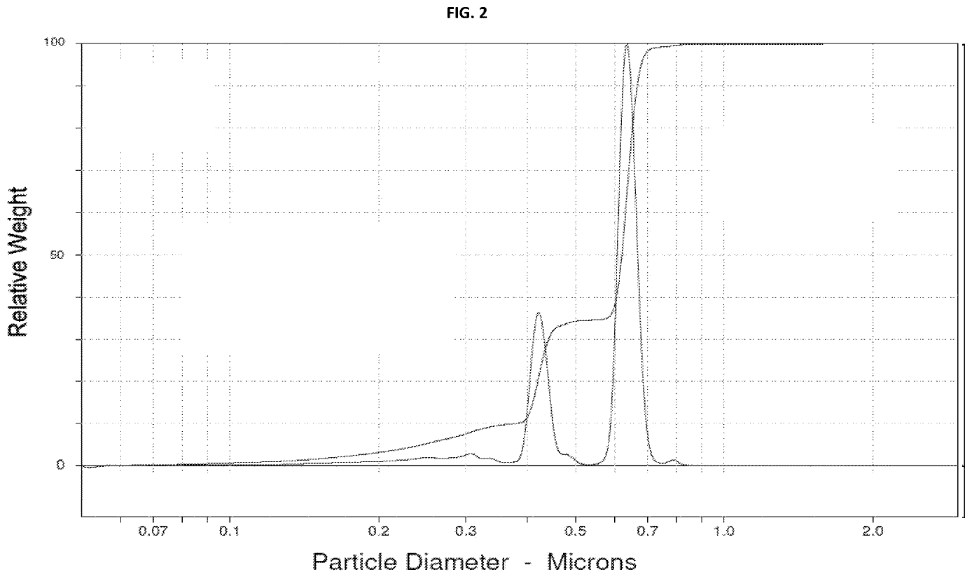

FIG. 3 is a graph showing particle size distribution for the water-based pressure-sensitive adhesive composition of inventive example 1.

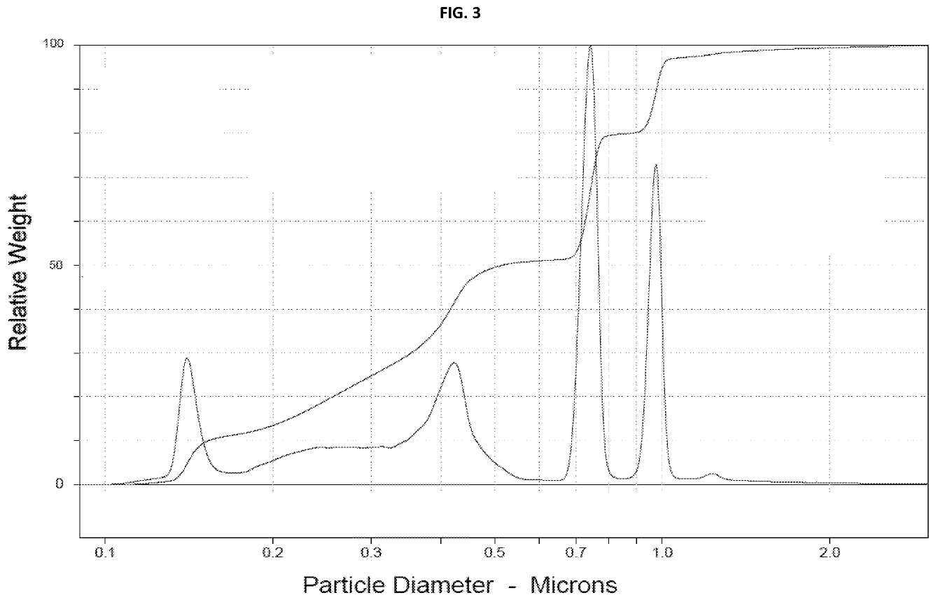

FIG. 4 is a graph showing particle size distribution for the water-based pressure-sensitive adhesive composition of inventive example 2.

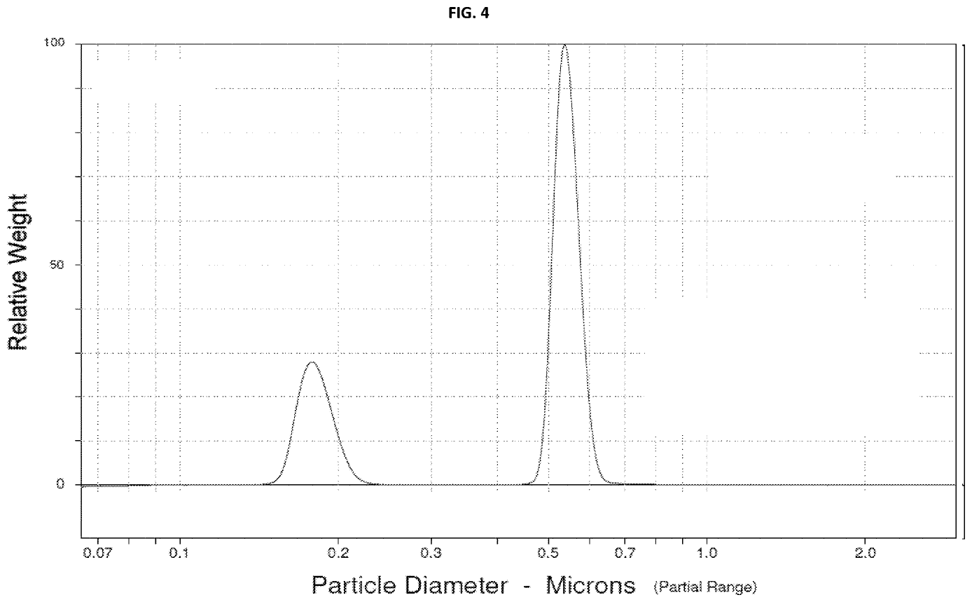

FIG. 5 is a graph showing particle size distribution for the water-based pressure-sensitive adhesive composition of inventive example 3.

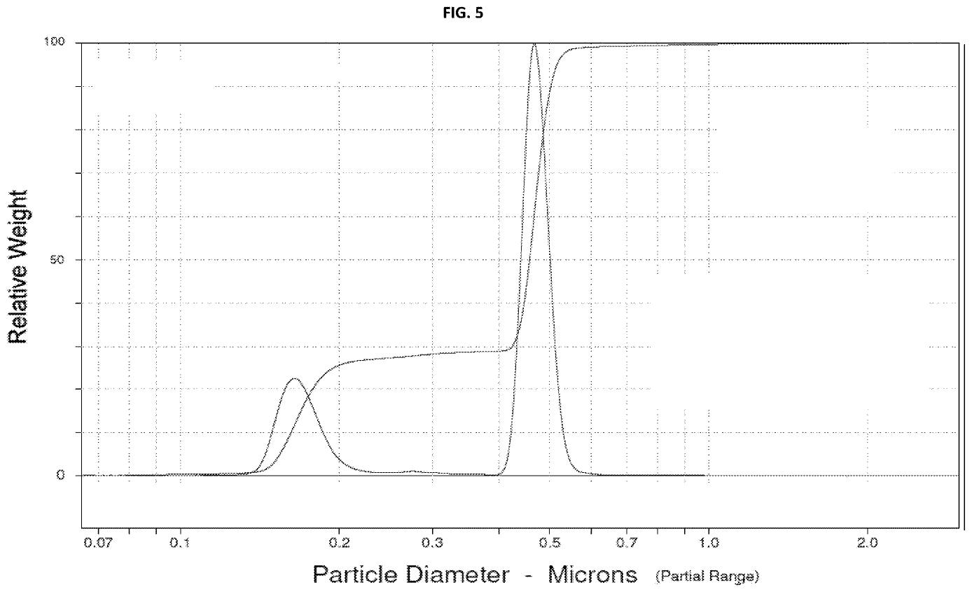

FIG. 6 is a graph showing particle size distribution for the water-based pressure-sensitive adhesive composition of inventive example 4.

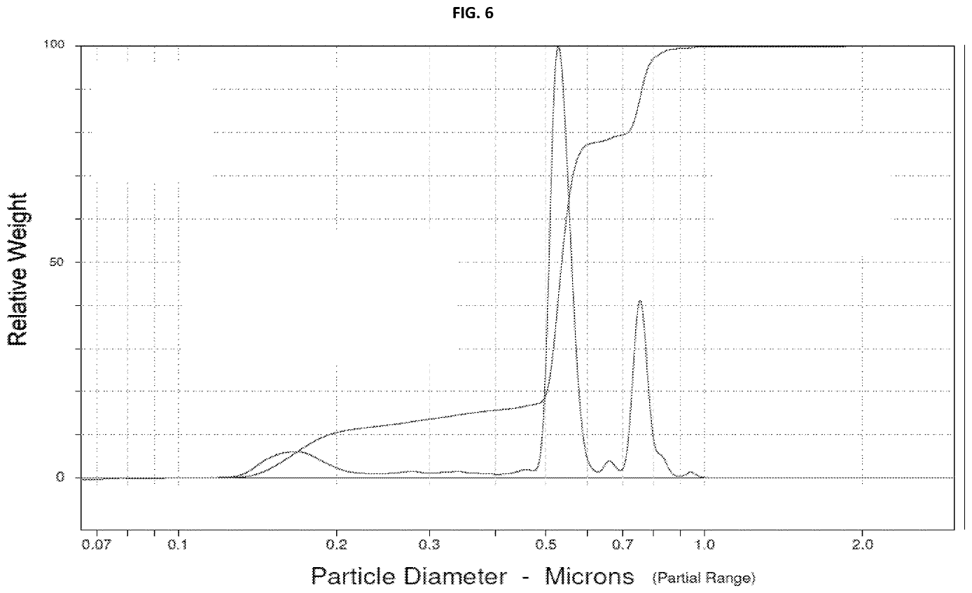

FIG. 7 is a graph showing particle size distribution for the water-based pressure-sensitive adhesive composition of inventive example 5.

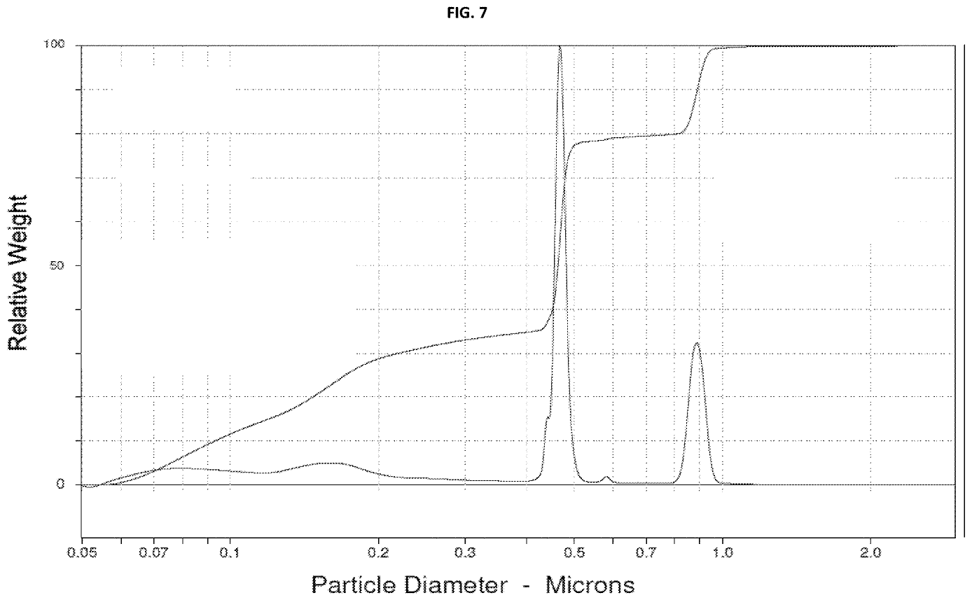

FIG. 8 is a graph showing particle size distribution for the water-based pressure-sensitive adhesive composition of inventive example 6.

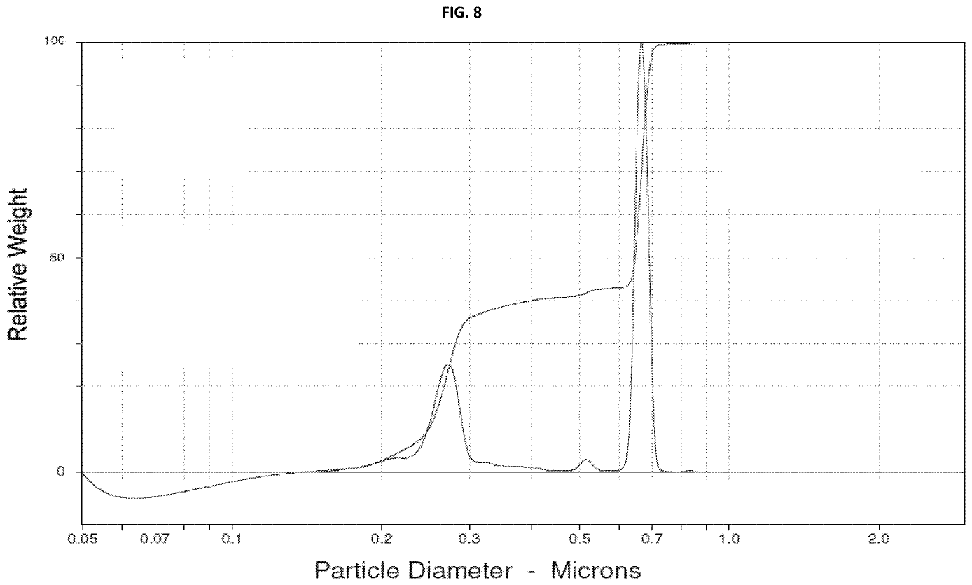

FIG. 9 is a graph showing particle size distribution for the water-based pressure-sensitive adhesive composition of inventive example 7.

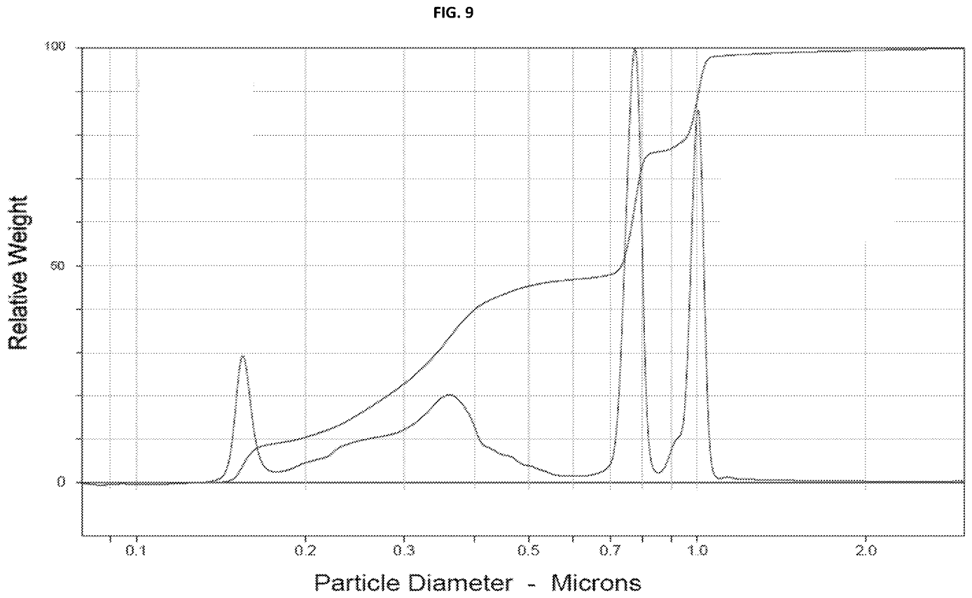

FIG. 10 is a graph showing particle size distribution for the water-based pressure-sensitive adhesive composition of inventive example 8.

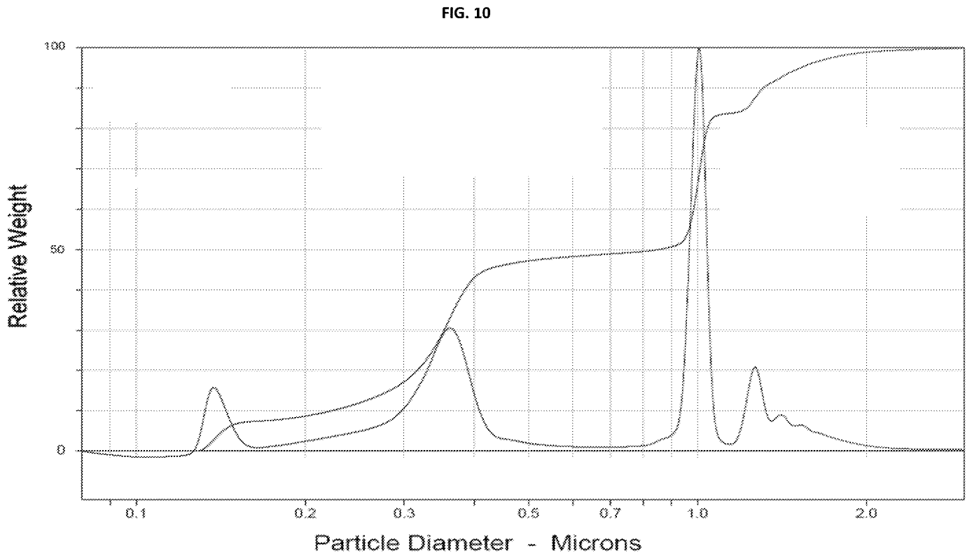

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

An “acrylic-based monomer,” as used herein, is a monomer containing the Structure (1) below:

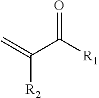

wherein R₁ is a hydroxyl group or a C₁-C₁₈ alkoxy group and R₇ is H or CH₃. Acrylic-based monomers include acrylic acid, methacrylic acid, acrylates, and methacrylates.

The terms “blend” or “polymer blend,” as used herein, is a blend of two or more polymers. Such a blend may or may not be miscible (not phase separated at molecular level). Such a blend may or may not be phase separated. Such a blend may or may not contain one or more domain configurations, as determined from transmission electron spectroscopy, light scattering, x-ray scattering, for example.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

### Test Methods

Adhesion Test (peel/tack). Samples are tested on both stainless steel (“SS”) and high density polyethylene (“HDPE”) test plates according to Federation Internationale des fabricants et transformateurs d'Adhésifs et Thermocollants (“FINAT”) Test Method No. 2. Cohesion/Shear Test: FINAT Test Method No. 8 is used for the shear resistance test on stainless steel plates. Failure mode is recorded behind the value of the tests: “AF” indicates adhesion failure. “AFB” indicates adhesion failure from the backing, i.e., the release liner. “CE” indicates cohesion failure. “ME” indicates mixture failure. FINAT is the European association for the self-adhesive label industry (Laan van Nieuw-Oost Indië 131-G, 2593 BM The Hague, P.O. Box 85612, 2508 CH The Hague, The Netherlands). Before testing, the sample strip was applied to test plate for dwell time of 20 minutes or 24 hours.

Loop Tack (PSTC Test Method 16) (Pressure Sensitive Tape Council, One Parkview Plaza, Suite 800, Oakbrook Terrace, IL 60101, USA) is performed as follows. The Loop Tack test measures the initial adhesion when the adhesive comes in contact with the substrate. Testing is conducted after the adhesive laminate is conditioned in a controlled environment (22.2 to 23.3 °C (72-74 °F), 50% relative humidity) for at least 1 day. A strip 2.54 cm (1 inch) wide is cut and folded over to form a loop, exposing the adhesive side. It is then placed in between the jaws of the INSTRON™ tensile tester, and the lower jaw is lowered at a rate of 12 in/min to the substrate such that a square area of the adhesive of 2.54 cm by 2.54 cm (1 inch×1 inch) comes in contact with the substrate for 1 second. Then the adhesive is pulled away and the peak force to pull the adhesive away from the substrate is recorded.

Differential Scanning Calorimetry (DSC). Differential Scanning Calorimetry (DSC) can be used to measure the melting, crystallization, and glass transition behavior of a polymer over a wide range of temperature. For example, the TA Instruments Q1000 DSC, equipped with an RCS (refrigerated cooling system) and an autosampler is used to perform this analysis. During testing, a nitrogen purge gas flow of 50 ml/min is used. A 3-10 mg sample is prepared in a light aluminum pan (ca 50 mg) by oven drying of polymer latex at 50 °C for 24 hours and crimped shut. Analysis is then performed to determine its thermal properties.

The thermal behavior of the sample is determined by ramping the sample temperature up and down to create a heat flow versus temperature profile. First, the sample is rapidly heated to 150 °C and held isothermal for 5 minutes in order to remove its thermal history. Next, the sample is cooled to −90 °C at a 10 °C/minute cooling rate and held isothermal at −90 °C for 5 minutes. The sample is then heated to 150 °C (this is the “second heat” ramp) at a 3 °C/minute heating rate. The cooling and second heating curves are recorded.

Glass transition temperature, Tg, is determined from the DSC heating curve where half the sample has gained the liquid heat capacity as described in Bernhard Wunderlich, The Basis of Thermal Analysis, in Thermal Characterization of Polymeric Materials 92, 278-279 (Edith A. Turi ed., 2d ed. 1997). Baselines are drawn from below and above the glass transition region and extrapolated through the Tg region. The temperature at which the sample heat capacity is half-way between these baselines is the Tg.

Molecular weight is determined by gel permeation chromatography (GPC) according to the following methods. Samples were prepared in tetrahydrofuran (THF) (High Performance Liquid Chromatography (HPLC) grade from Fisher) at concentration of about 2 milligrams polymer solids per gram (mg/g). Samples were left to equilibrate on a mechanical shaker overnight at ambient temperature (about 25 °C). Sample solutions were filtered using 0.45 microns (μm) polytetrafluoroethylene (PTFE) filters prior to subjecting the sample solutions to an SEC (size exclusion chromatography) method.

### SEC Separation Set-Up

SEC separations were carried out on a liquid chromatograph consisting of an Agilent 1100 Model isocratic pump, vacuum degasser, variable injection size autosampler, and Agilent 1100 HPLC G1362A Refractive Index detector. Agilent ChemStation, version B.04.03 with Agilent GPC-Addon version B.01.01 were used to process the data.

SEC separations were performed in THE (HPLC grade from Fisher) at 1 milliliter/minute (mL/min) using a SEC column set composed of two PLgel MIXED-D columns (available from Agilent) in neat THE with narrow-fraction polystyrene standards from 580 Daltons to 371,000 Daltons fitted with 1st order fit calibration curve. 100 microliters (μL) of sample were subjected to SEC separation.

### SEC Separation Conditions

Columns: PLgel MIXED-D columns (300×7.5 millimeters (mm) internal diameter (ID)) plus guard (50 mm×7.5 mm ID), particle size 5 μm
Eluent: THE (HPLC grade Fisher)
Flow rate: 1.0 mL/min
Sample solvent: THE
Sample concentration: ^{~}2 mg/g (0.2%)
Injected volume of sample solution: 100 μL
   Calibration: Narrow-fraction polystyrene standards having peak molecular weight in the range from 580 Daltons to 371,000 Daltons with a concentration of about 0.5 milligrams per milliliter (mg/mL) in THE were used to construct a 10-point calibration curve (1st order fit) which was used to evaluate the relative molecular weight of analyzed sample. The detection method is refractive index (RI).

Number average molecular weight, Mn, of a polymer is expressed as the first moment of a plot of the number of molecules in each molecular weight range against the molecular weight. In effect, this is the total molecular weight of all molecules divided by the number of molecules and is calculated in the usual matter according to the following formula:

Mn=Σnᵢ*Mᵢ/Σn_{I}=Σwᵢ/Σ(wᵢ/Mᵢ)

wherein,
nᵢ=number of molecules with molecular weight Mᵢ
wᵢ=weight fraction of material having molecular weight Mᵢ and
Σnᵢ=total number of molecules.

Weight average molecular weight, M_{w}, is calculated in the usual manner according to the following formula: M_{w}=Σwᵢ*Mᵢ, where wᵢ and Mᵢ are the weight fraction and molecular weight, respectively, of the i^{th} fraction eluting from the GPC column. The ratio of these two averages, the molecular weight distribution (MWD or M_{w}/Mₙ), is used herein to define the breadth of the molecular weight distribution.

The term “polymodal particle size distribution,” as used herein, is a plurality of particles having a distribution of particle sizes discriminated according to mass fractions characterized by a polydispersity index Q (or “PDi”):

$$Q = \frac{{d}_{90} - {d}_{10}}{{d}_{50}}$$

wherein,
d₁₀ is the particle diameter below which 10% by weight of the polymer particles fall,
d₅₀ is the particle diameter below which 50% by weight of the polymer particles fall, and
d₉₀ is the particle diameter below which 90% by weight of the polymer particles fall.
   A polymodal particle size distribution differs from a monomodal particle size distribution (i.e., a single distribution, or a Gaussian distribution); a polymodal particle size distribution possessing at least two pronounced maxima, which differ by at least 50 nm, or differ by at least 100 nm. Whereas a monomodal particle size distribution is characterized by a PDi (or Q value) of less than 0.3, or a PDi from 0.05 to 0.3, a polymodal particle size distribution has a PDi (or Q value) greater than 0.3, or a PDi value from 0.4, or 0.5, or 0.6 to 1.2, or 1.5, or 2.0. Stated differently, the polymodal particle size distribution has a PDi (or Q value) from 0.4 to 2.0, or from 0.5 to 1.5, or from 0.6 to 1.2.

Particle size distribution is measured with a CPS Disc Centrifuge Photosedimentometer 24000 (DCP) Particle Size Analyzer which employs the technique of differential centrifugal sedimentation within an optically clear spinning disc to measure the hydrodynamic radius (Rₕ) of particles. Sedimentation is stabilized by a sucrose gradient (density gradient) within the disc. The spinning disc hastens the sedimentation and the detector only measures part or a ‘differential’ of the distribution at a time. Emulsion samples are diluted in DI water containing 0.1% sodium lauryl sulfate. These dilute samples are injected into the spinning disc and bands of particles are separated and measured as they pass through the detector beam. The turbidity of the fluid near the outside edge of the disc is measured and converted to weight distributions by Mie Theory light scattering calculations. Particle size modes reported are dependent on the particle density (or polymer density) and refractive index, calibration standard particle density and diameter, as well as the sucrose gradient and disc speed. The Disc Centrifuge can determine the particle size of emulsion products in the range of 20 nm to 20 microns. The sample analysis time is dependent on the particle size and density.

Two discs were used for these analyses. The standard disc, where the sample is introduced to the center of the disc and the particles sediment outwardly toward the edge of the disc. The standard disc is usually used for particles with densities greater than 1.03 g/cm³. The low-density disc is usually used when the particle density is less than 1.03 g/cm³. Samples are introduced to the low-density disc at the outer edge and particles float toward the detector.

### Specific Conditions Using the Low-Density Disc and Method 1:

Sample dilution 3 drops in 10 mL 32% sucrose with SLS.
Gradient solution 16% to 28% sucrose.
Maximum Diameter: 3.0
Minimum Diameter: 0.09
Disc Speed: 24000 RPM
Cal. Standard Diameter: 0.882 Microns
Cal. Standard Density: 1.022 g/ml
Particle Density: 1.029 g/ml
Particle Refr. Index: 1.49
Particle Absorption: 0.0
Particle Non-sphericity: 1.0
Fluid Density: 1.086 g/ml
Fluid Refr. Index: 1.366

### Specific Conditions Using the Standard Disc and Method 2:

Sample dilution 1 drop in 10 mL DI water with SLS.
Gradient solution 2% to 8% sucrose
Maximum Diameter: 3.0 microns
Minimum Diameter: 0.05 microns
Disc Speed: 22000 RPM
Cal. Standard Diameter: 0.596 Microns
Cal. Standard Density: 1.052 g/ml
Particle Density: 1.06 g/ml
Particle Refractive Index: 1.47
Particle Absorption: 0.0
Particle Non-sphericity: 1.0
Fluid Density: 1.015 g/ml
Fluid Refractive Index: 1.341

Dispersion solids content is measured by weighing about 1 g of dispersion on a weighed aluminum pan, recording this initial weight, heating the dispersion in the pan in an oven at 150 °C for 30 minutes, and re-weighing the sample for the final weight. The solids content is defined as follows:

$$Solids content = \frac{P a n + sample final weight - Empty pan weight}{P a n + s ample initial weight - Empty pan weight}$$

Dispersion viscosity, e.g. at 65.5 wt % solids, is measured using a Brookfield Viscometer Model, and a Brookfield RV-DV-II-Pro viscometer spindle #3, at 25 °C after bringing the dispersion sample to 25 °C using a water bath. The sample is poured into a wide mouth cup and enough volume is poured in that when the viscometer apparatus is lowered, the spindle should be completely submerged into the dispersion. The viscometer is turned on and set to operate at a shear rate of 30 RPM. Readings are monitored for 15 minutes, or until the values stabilize, at which point, a final reading is recorded.

### DETAILED DESCRIPTION

The present disclosure is directed to a water-based pressure-sensitive adhesive composition. In an embodiment, the water-based pressure-sensitive adhesive composition includes a plurality of particles having a polymodal particle size distribution. The particles are composed of (A) a first polymer and (B) a second polymer different than the first polymer. The particles have a d₅₀ greater than 450 nm and a polydispersity index, PDi, from 0.5 to 2.0. The composition (C) has a solids content greater than or equal to 65.5 wt %.

In an embodiment, the water-based pressure-sensitive adhesive composition is void of a thickener, or otherwise excludes a thickener, and the composition has a viscosity less than 650 cps at 65.5 wt % solids content.

The water-based pressure-sensitive adhesive composition includes a plurality of particles, a surfactant, and water. The particles have a polymodal particle size distribution. The particles are composed of (A) a first polymer and (B) a second polymer different than the first polymer. The first polymer (A) is an acrylic-based polymer with a glass transition temperature (Tg) less than −20 °C. The second polymer (B) is an acrylic-based polymer with a glass transition temperature (Tg) greater than −20 °C. The second polymer is “different than” the first polymer by having (i) dissimilar monomer types, and/or (ii) dissimilar monomer weight percent, and/or (iii) dissimilar Mn, and/or (iv) dissimilar Mw, and/or (v) a dissimilar Tg when compared to the first polymer. An “acrylic-based polymer,” as used herein, is a polymer having a majority amount of one or more acrylic-based monomers, based in total weight of the acrylic-based polymer.

The surfactant acts as an emulsifier and enables droplets of the acrylic-based monomer, which is hydrophobic, to form throughout the aqueous medium. An initiator is then introduced into the emulsified mixture. The initiator reacts with the acrylic-based monomer(s) dispersed throughout the aqueous medium until all, or substantially all, of the acrylic-based monomer(s) is polymerized. The end result is an acrylic dispersion composed of a dispersion of acrylic-based polymer particles in the aqueous medium, the acrylic-based polymer particles composed of one or more acrylic-based monomer subunits.

The first acrylic-based polymer has a Tg less than −20 °C, or from −80 °C to −20 °C, or from −70 °C to −30 °C, or from −60 °C to −35 °C. The second acrylic-based polymer has a Tg greater than −20 °C, or from −20 °C to 80 °C, or from −20 °C to 60 °C, or from −20 °C to 50 °C.

The first acrylic-based polymer and the second acrylic-based polymer each is composed of two or more acrylic-based monomers. Nonlimiting examples of suitable acrylic-based monomers include acrylic acid (AA), butyl acrylate (BA), ethylhexyl acrylate (2-EHA), ethyl acrylate (EA), methyl acrylate (MA), octyl acrylate, isooctyl acrylate, decyl acrylate, isodecyl acrylate, lauryl acrylate, cyclohexyl acrylate, methyl methacrylate (MMA), isobutyl methacrylate, octyl methacrylate, isooctyl methacrylate, decyl methacrylate, isodecyl methacrylate, lauryl methacrylate, pentadecyl methacrylate, stearyl methacrylate, n-butyl methacrylate, C₁₂ to C₁₈ alkyl methacrylates, cyclohexyl methacrylate, methacrylic acid, and combinations thereof. In addition to acrylic-based monomer, the first acrylic-based polymer and the second acrylic-based polymer each may also comprise other unsaturated monomers. The unsaturated monomer may comprise α,β-monoethylenically unsaturated dicarboxylic acids of 3 to 6 carbon atoms, such as itaconic acid, fumaric acid and maleic acid, and the anhydrides of mono-olefinically unsaturated dicarboxylic acids, such as maleic anhydride and itaconic anhydride, or a monoethylenically unsaturated sulfonic acid such as vinylsulfonic acid, methallylsulfonic acid, 2-acrylamido-2-methylpropanesulfonic acid. In an embodiment, the second acrylic-based polymer comprises less than 5% of monomer units of unsaturated acid comonomers such as acrylic acid and methacrylic acid. In another embodiment, the second acrylic-based polymer excludes unsaturated acid comonomers. Greater than 5% of monomer units of unsaturated acid comonomers in the second acrylic-based polymer could result in a thickening effect when the dispersion is neutralized which could make it difficult to handle and process. The unsaturated monomer may comprise a vinylaromatic monomer such as styrene, α-methylstyrene, vinyltoluene, 4-n-butylstyrene, and 4-tert-butylstyrene, a vinyl ester of an aliphatic C₂-C₁₀ carboxylic acid such as vinyl acetate and vinyl propionate, or a monoethylenically unsaturated nitrile such as acrylonitrile and methacrylonitrile. The unsaturated monomer may comprise an amide of a monoethylenically unsaturated C₃-C₈ monocarboxylic acid such as acrylamide and methacrylamide, and a hydroxy-C₂-C₄ alkyl ester of a monoethylenically unsaturated C₃-C₈ monocarboxylic acid, more particularly a C₂-C₄ hydroxyalkyl acrylate and methacrylate such as 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 4-hydroxybutyl acrylate, and 4-hydroxybutyl methacrylate. In some embodiments, the unsaturated monomer is styrene, vinyl acetate, and combinations thereof.

In an embodiment, the first acrylic-based polymer includes, in addition to the aforementioned monomers, a small amount of polyethylenically unsaturated monomer, which when the polymer is prepared results in crosslinking. Nonlimiting examples of polyethylenically unsaturated monomers include diesters and triesters of ethylenically unsaturated carboxylic acids, more particularly the bis- and trisacrylates of diols or polyols having three or more OH groups, nonlimiting examples being the bisacrylates and the bismethacrylates of ethylene glycol, diethylene glycol, triethylene glycol, neopentyl glycol or polyethylene glycols, vinyl and allyl esters of saturated or unsaturated dicarboxylic acids, the vinyl and allyl esters of monoethylenically unsaturated monocarboxylic acids, and polyethylenically unsaturated aromatic monomers such as divinylbenzene. The fraction of the polyethylenically unsaturated monomers, does not exceed, based upon the total weight of monomers in the monomer mixture, 1 weight percent, or 0.5 weight percent, or 0.1 weight percent.

The first acrylic-based polymer has a number average molecular weight, Mn, from 50,000 daltons to 5,000,000 daltons, or from 50,000 daltons, to 1,000,000 daltons, or from 50,000 daltons to 500,000 daltons, or 50,000 daltons to 250,000 daltons, or from 75,000 daltons to 125,000 daltons; and a weight average molecular weight, Mw, from 100,000 daltons to 5,000,000 daltons, or from 250,000 daltons, to 2,000,000 daltons, or from 300,000 daltons to 750,000 daltons. The second acrylic-based polymer has a number average molecular weight, Mn, from 1,000 daltons to 35,000 daltons, or from 1,000 daltons, to 25,000 daltons, or from 2,000 daltons to 10,000 daltons, or from 3,000 daltons to 7500 daltons; and a weight average molecular weight, Mw, from 1,000 daltons to 50,000 daltons, or from 2,000 daltons, to 20,000 daltons, or from 3,000 daltons to 10,000 daltons.

In an embodiment, the ratio of the weight of the first polymer to the weight of the second polymer is from 95:5 to 50:50, or from 93:7 to 60:40, or from 92:8 to 70:30, or from 90:10 to 75:25, where the weight of the first polymer is calculated from the sum of the weights of the monomer units of the first polymer, and the weight of the second polymer is calculated from the sum of the weights of the monomer units of the second polymer.

For preparing aqueous polymer dispersions, it is possible to use processes for preparing polymer dispersions having a polymodal particle size distribution. Nonlimiting examples of suitable processes include the mixing of two or more different polymer dispersions with unique monomodal or polymodal particle size distribution(s) differing in their average particle size. Another suitable process is to prepare the polymer dispersions by way of a free-radical aqueous emulsion polymerization of ethylenically unsaturated monomers in the presence of two or more different seed latices, which differ in their average particle size. Another suitable process that may be employed for preparing the polymer dispersion is to carry out a free-radical aqueous emulsion polymerization of the monomers by a feed process and during the course of the polymerization, when some of the monomers have already undergone polymerization, a larger quantity of emulsifier is added, (e.g., a surfactant intercept), which initiates the formation of a new particle generation. Another suitable process that may be employed for preparing the polymer dispersion is to carry out a free-radical aqueous emulsion polymerization of the monomers by a feed process and during the course of the polymerization feed an excess quantity of emulsifier to the polymerization reactor such that new particles are formed throughout the polymerization to yield a polymodal particle size distribution.

In an embodiment, the present water-based pressure-sensitive adhesive composition is provided by way of a free-radical aqueous emulsion polymerization of the monomers which include the polymer. In this process, a free radical, aqueous emulsion polymerization of the ethylenically unsaturated monomers is carried out according to a monomer feed process in which at least one seed latex A is included in the initial charge to the polymerization reactor, and at least one further seed latex B, in the form of an aqueous dispersion, is added during course of the polymerization. The seed latex B is added to the polymerization reactor continuously during the monomer feed. Alternatively, the seed latex B is added to the polymerization reactor during a discrete interval at a defined point during the monomer feed. In an embodiment, the seed latex B is added to the polymerization reactor at a defined point when 20% to 60% of the total amount of monomer has been added to the polymerization reactor. The interval over which the seed latex B is added to the polymerization reactor is less than fifteen minutes, or less than 10 minutes, or less than five minutes.

The term “seed latex” is understood to refer to an aqueous polymer dispersion. The weight-average particle size of the seed latexes used in the process of the invention (weight average, d₅₀) is less than 500 nm, or from 10 to 400 nm, or from 30 to 250 nm. The initial seed latex or latexes A, located in the polymerization reactor at the start of the polymerization, have a weight-average particle size from 30 to 400 nm. As for the further seed latex B, added in the course of the polymerization, the weight-average particle size is from 30 to 400 nm, or from 30 to 100 nm.

In an embodiment, the seed polymers are composed predominantly of vinylaromatic monomers and more particularly of styrene (so-called styrene seed), or predominantly of C₁-C₁₀ alkyl acrylates and/or C₁-C₁₀ alkyl methacrylates, such as from a mixture of butyl acrylate and methyl methacrylate, for example. Besides these principal monomers, which typically account for at least 80% by weight and more particularly at least 90% by weight of the seed polymer, the seed polymers may include, in copolymerized form, monomers different from these, more particularly monomers having a heightened water solubility, nonlimiting examples being monomers having at least one acid function and/or neutral monomers with an increased water solubility. The fraction of such monomers will generally not exceed 20% and more particularly 10% by weight, and, where they are present, are situated typically in the range from 0.1% to 10% by weight, based on the total amount of the monomers which constitute the seed polymer.

The first seed polymer A is typically used in an amount from 0.05% to 4%, or from 0.2% to 2%, by weight, based on the total solids content of the seed polymer to amount of the monomers to be polymerized.

The seed polymer B, added in the course of the polymerization reaction, is used in an amount from 0.05% to 2%, or from 0.1% to 1%, by weight, based on the total solids content of the seed polymers to the total amount of the monomers to be polymerized.

Through the amount of the seed latex A and/or through the ratio of seed latex A to the monomers it is possible to adjust the maximum particle size of the polymer particles in the dispersion. A small fraction of seed latex A, based on the monomers, leads in general to larger polymer particles, whereas a larger amount of seed latex A leads in general to smaller polymer particles. The time of the addition of the second seed latex, and the weight ratio of seed latex B to the monomers, are used to make adjustments, in particular, to the particle size and the weight fraction of the smaller polymer particles in the dispersion. The earlier the second seed latex B is added, the higher the fraction of smaller polymer particles in the polymer dispersion. At the same time, however, there is an increase in the size of the smaller particles, and so the d₁₀ figure on early addition of the seed latex B is larger than in the case of a later addition. Similar considerations apply to the amount of the seed latex B. The larger the ratio of seed latex B to the monomers to be polymerized, the greater the fraction of smaller polymer particles and the greater the d₁₀ figure for the particle size distribution.

The particles composed of (A) the first acrylic-based polymer and (B) the second acrylic-based polymer have a polymodal particle size distribution, a d₅₀ greater than 450 nm and a polydispersity index, PDi, from 0.5 to 2.0. In an embodiment, the particles composed of (A) the first acrylic-based polymer and (B) the second acrylic-based polymer have one, some, or all of the following properties:
(i) a d₅₀ from 455 nm to 1.0 micron, or from 455 nm to 800 nm; and/or
(ii) a PDi from 0.5 to 2.0, or from 0.5 to 1.8; and/or
(iii) a d₉₀/d₁₀ from 2.5 to 20.0, or from 2.5 to 10.0.

The water-based pressure-sensitive adhesive composition includes a surfactant. Nonlimiting examples of suitable surfactant include cationic surfactants, anionic surfactants, zwitterionic surfactants, non-ionic surfactants, and combinations thereof. Examples of anionic surfactants include, but are not limited to, sulfonates, carboxylates, and phosphates. Examples of cationic surfactants include, but are not limited to, quaternary amines. Examples of non-ionic surfactants include, but are not limited to, block copolymers containing ethylene oxide and silicone surfactants, such as ethoxylated alcohol, ethoxylated fatty acid, sorbitan derivative, lanolin derivative, ethoxylated nonyl phenol, or alkoxylated polysiloxane. Commercially-available examples of suitable surfactants include, but are not limited to, surfactants sold under the trade names TERGITOL™ and DOWFAX™ by The Dow Chemical Company, such as TERGITOL™ 15-S-9 and DOWFAX™ 2A1, products sold under the DISPONIL trade name by BASF SE, such as DISPONIL FES 77 IS and DISPONIL FES 993, and products sold under the AEROSOL trade name by Solvay, such as AEROSOL A-102 and AEROSOL OT-75. The amount of surfactant is typically in the range from 0.1% to 10%, preferably 0.2% to 5%, by weight, based on 100% by weight of polymer or on 100% by weight of the monomers which constitute the polymer.

The initiators used for the emulsion polymerization are typically water-soluble substances that form free radicals. Water-soluble initiators for the emulsion polymerization can be organic or inorganic peroxide compounds, i.e., compounds having at least one peroxide or hydroperoxide group, examples include ammonium salts and alkali metal salts of peroxodisulfuric acid, e.g. sodium peroxodisulfate, hydrogen peroxide, or organic peroxides such as tert-butyl hydroperoxide. The initiator can also be a reduction-oxidation (redox) initiator system. The redox initiator systems are composed of at least one, usually inorganic reducing agent and one organic or inorganic oxidizing agent. The oxidizing component can be composed of, for example, the peroxide compounds stated above. The reducing components are comprised, for example, of alkali metal salts of sulfurous acid, such as sodium sulfite, sodium hydrogen sulfite, alkali metals salts of disulfurous acid such as sodium disulfite, bisulfite addition compounds with aliphatic aldehydes and ketone, such as acetone bisulfite, or reducing agents such as hydroxymethanesulfinic acid and its salts, BRUGGOLITE FF6 (from Bruggeman), or ascorbic acid. Then redox initiator system can be used in combination with soluble metal compounds. The typical redox initiator pairs are, for example, ascorbic acid/iron(II) sulfate/sodium peroxidisulfate, and tert-butyl hydroperoxide/sodium disulfite, tert-butyl hydroperoxide/sodium hydroxymethanesulfinic acid.

The amount of initiator is generally from 0.1% to 10%, or from 0.3-5%, by weight, based on the monomers to be polymerized. It is also possible to use two or more different initiators in the same emulsion polymerization.

It is also possible to use molecular regulators or chain-transfer agents in the polymerization in the amounts from 0% to 5% by weight, for example, based on the monomers to be polymerized. Using this method, the molecular weight of the polymer can be reduced. One can target a particular molecular weight of the polymer dispersion by controlling the ratio of the monomers to the amount of regulator, with greater amounts of the regulator resulting in polymers of lower molecular weight. Suitable chemical regulators include compounds possessing a thiol group, such as tert-butyl mercaptan, mercaptoethanol, thioglycolic acid, thioglycolic acid ethyl ester, mercaptopropyltrimethoxysilane, and tert-dodecyl mercaptan, n-dodecyl mercaptan (n-DDM), 3-mercaptopropionic acid, and its esters such as methyl 3-mercaptopropionate (MMP) and butyl 3-mercaptopropionate. In an embodiment, the regulator is a transition metal chelate complex such as a cobalt (II) or (III) chelate complex. The regulator can be added throughout the entire course of the polymerization, for example by adding it to the monomer emulsion to be fed continually to the reactor. Alternatively, it can be added separately at any time during the reaction to be fed at a continuous or varying rate. In a preferred embodiment, the regulator is added to the second stage monomer emulsion (B) to create a final composition where the composition of polymer A, resulting from monomer emulsion (A) has a greater molecular weight than the molecular weight of polymer B. In a preferred embodiment, the regulator is added to the first stage monomer emulsion (A) and the second stage monomer emulsion (B) to create a final composition where the composition of first polymer A, resulting from monomer emulsion (A), has a greater molecular weight than the molecular weight of second polymer B.

The amount of regulator used to make the polymer A or polymer B can be dependent on the specific regulator used and the amounts of the other components in the polymerization. However, as an illustrative embodiment, and not to be limited thereby, when the regulator used in the polymerization step of polymer B is, for example, n-DDM, the amount of regulator can be from 0.5 wt % to 20 wt %; or when the regulator used in the present invention is, for example, MMP, the amount of chain transfer agent can be from 0.3 wt % to 12 wt % based on the weight of the regulator as a fraction of the total weight of the regulator and the monomers comprising polymer B. In the embodiment when the regulator is n-DDM or MMP, the amount of the regulator to employ to achieve a targeted Mn as a fraction of the total weight of the regulator and the monomers comprising polymer B (w_{regulator}) may be estimated according to the following equation where z_{regulator} is the molecular weight of the regulator:

$${w}_{r egulator} = \frac{{z}_{r egulator}}{M n}$$

The process is performed as feed process, i.e., at least 95% of the monomers to be polymerized are added to the polymerization reactor under polymerization conditions during the polymerization. The addition may be made continuously or in stages. In the course of the polymerization, the monomer composition may be changed at least once in order to prepare the first polymer A and second polymer B.

A preferred procedure is to provide water as an initial charge in the polymerization reactor, to add a portion of the polymerization initiator, and then to charge the first seed latex or latexes A in the form of an aqueous dispersion, optionally together with water. This is followed by the addition of the monomers to be polymerized to the polymerization reactor under polymerization conditions. The addition takes place typically over a period from at least 30 minutes, or from 30 minutes to 10 hours, or over a period from 1 hour to 6 hours. As already described, the addition may take place with a constant, an increasing, or a decreasing rate of addition. In an embodiment, the addition takes place at the beginning of the polymerization, with an increasing feed rate. Alternatively, the addition takes place with a constant addition rate. The monomers can be added as they are. Preferably the monomers are added in the form of an aqueous monomer emulsion, which includes at least part, at least 70% by weight, of the surface-active substances used in the emulsion polymerization. This monomer emulsion customarily has a monomer content in the range from 60% to 90%. It is possible to add the monomers or the monomer emulsion to the polymerization reactor via two or more feed streams, it being possible for the monomer composition of the individual feed streams to be different from one another. In general, however, it is sufficient to add the monomers as a mixture via one feed stream into the polymerization reactor. Where the monomers are added to the polymerization reactor in the form of an aqueous emulsion, it is advantageous to provide fresh emulsification of the monomers immediately prior to their addition and in line with their addition in the polymerization reactor, by a continuous method, for example. It is also possible to prepare the monomer emulsion first of all and then to introduce it into the polymerization reactor at the desired addition rate.

Typically, in parallel with the addition of monomer, at least a portion of the entirety of the polymerization initiator is added. The polymerization initiator may be added at a constant rate, or a decreasing rate, or an increasing rate, for example.

In an embodiment, the adhesive compositions, in which the particles are composed of (A) a first polymer and (B) a second polymer different than the first polymer, are prepared using a two-stage process. A first monomer solution is provided and polymerized to form polymer A in the first stage, optionally in the presence of a regulator. In the second stage, a second monomer solution is provided and is polymerized in the presence of a regulator to provide polymer B. Alternatively, a first monomer solution is provided and polymerized in the presence of a regulator to form polymer B in the first stage. In the second stage, a second monomer solution is provided and is polymerized, optionally in the presence of a regulator, to provide polymer A. The initiator used in each polymerization may be the same or different. The polymerization to form polymer A is conducted using an ammonium salt or an alkali metal salt of peroxodisulfuric acid as an initiator. Alternatively, the polymerization to form polymer B is conducted using a redox initiator system. For efficiency, these two stages may be conducted in a single vessel to prepare the polymer dispersion.

The emulsion polymerization takes place at a temperature from 30 to 130 °C, or from 50 to 90 °C. The polymerization pressure is situated typically in the region of atmospheric pressure, i.e., at ambient pressure, but may also be slightly above or below this, in the range from 800 to 1500 mbar, for example.

At the end of the addition of the monomers to be polymerized, or after a conversion of at least 95% of the monomers located in the polymerization reactor, a chemical and/or physical deodorization is performed for the purpose of removing unpolymerized monomers. A chemical deodorization is a postpolymerization phase which is initiated by addition of at least one further polymerization initiator, more particularly by way of one of the aforementioned redox initiator systems. In an embodiment, the chemical deodorization step may be combined with the second polymerization stage such that the feeding of the initiator continues after the feeding of the monomer to accomplish the chemical deodorization. The lowering of the residual monomers may also take place through combined measures of chemical and physical deodorization, in which case the physical deodorization is preferably carried out after the chemical deodorization. The polymer dispersions thus obtained include less than 1500 ppm, or less than 1000 ppm, or less than 500 ppm of residual monomer species.

Before the polymer dispersion is used, a base is typically added to adjust the pH to a desired range. Examples of bases used include, but are not limited to, ammonium hydroxide, sodium hydroxide, potassium hydroxide, triethanolamine. A preferred base is ammonia.

### A. Tackifier

In an embodiment, the water-based pressure sensitive adhesive composition includes a tackifier which is different than the first polymer and the second polymer. Suitable tackifiers include, but are not limited to, rosin resins including rosin acid and/or rosin ester obtained by esterifying rosin acid with alcohols or an epoxy compound and/or its mixture, non-hydrogenated aliphatic C₅ resins, hydrogenated aliphatic C₅ resins, aromatic modified C₅ resins, terpene resins, hydrogenated C₉ resins, (meth)acrylic resins, and combinations thereof. (Meth)acrylic resins suitable as tackifiers are described in references U.S. Pat. No. 4,912,169, US 2002/055587, and U.S. Pat. No. 9,605,188. The water-based pressure-sensitive adhesive composition contains from greater than 0 wt % to 50 wt %, or from 5 wt % to 40 wt %, or from 7 wt % to 30 wt %, or from 8% to 15 wt % of the tackifier based on total dry weight of the water-based pressure sensitive adhesive composition.

### B. Additives

The water-based pressure sensitive adhesive composition may further include one or more optional additives. When the additive is present, nonlimiting examples of suitable additives include thickener, defoamer, wetting agent, mechanical stabilizer, pigment, filler, freeze-thaw agent, neutralizing agent, plasticizer, adhesion promoter, biocide and combinations thereof.

In an embodiment, the water-based pressure sensitive adhesive composition includes from greater than 0 wt % to 5 wt % thickener, based on the total dry weight of the water-based pressure sensitive adhesive composition. Suitable thickeners include, but are not limited to, ACRYSOL™, UCAR™ and CELLOSIZE™ which are commercially available from The Dow Chemical Company, Midland, Michigan.

In an embodiment, the water-based pressure-sensitive adhesive composition includes a thickener, and water-based pressure-sensitive adhesive composition has a viscosity from 500 cP to 3000 cP.

### C. PSA Composition

The water-based pressure-sensitive adhesive composition includes:
a plurality of particles having a polymodal particle size distribution, the particles composed of
(A) a first polymer;
(B) a second polymer different than the first polymer;
the particles having a d₅₀ greater than 450 nm and a polydispersity index, PDi, from 0.5 to 2.0; and
(C) the composition has (i) a solids content greater than or equal to 65.5 wt %. In a further embodiment, the composition is void of a thickener, or otherwise excludes a thickener, and the composition has (ii) a viscosity less than 650 cps.

In an embodiment, the water-based pressure-sensitive adhesive composition includes
(A) a first polymer that is an acrylic-based polymer having
   (i) a Tg from −80 °C to −20 °C,
   (ii) a Mn from 50,000 daltons to 5,000,000 daltons, or from 50,000 daltons to 250,000 daltons,
   (iii) a Mw from 100,000 daltons to 5,000,000 daltons, or from 300,000 daltons to 750,000 daltons,
(B) a second polymer different than the first polymer, the second polymer is an acrylic-based polymer having
   (i) a Tg from −20 °C to 80 °C,
   (ii) a Mn from 1,000 daltons to 35,000 daltons, or from 2,000 daltons to 10,000 daltons,
   (iii) a Mw from 1,000 daltons to 50,000 daltons, or from 3,000 daltons to 10,000 daltons;
the ratio of the weight of the first polymer to the weight of the second polymer being from 95:5 to 50:50 or from 90:10 to 75:25;
the particles having
(i) a d₅₀ from 455 nm to 1.0 micron, or from 455 nm to 800 nm, and a PDi, from 0.5 to 2.0, or from 0.5 to 1.8; and
(ii) a d₉₀/d₁₀ from 2.5 to 20.0, or from 2.5 to 10.0; and
(C) the composition has (i) a solids content from greater than or equal to 65.5 wt % to 75 wt %. In a further embodiment, the composition is void of a thickener, or otherwise excludes a thickener, and the composition has (ii) a viscosity less than 650 cps.

### D. Article

The present disclosure provides an article. The article includes a first substrate and a layer of a dried water-based PSA composition on the first substrate (hereafter PSA layer). The water-based PSA composition is any water-based PSA composition as previously disclosed herein and includes a plurality of particles having a polymodal particle size distribution, the particles composed of
(A) a first polymer;
(B) a second polymer different than the first polymer;
the particles having a d₅₀ greater than 450 nm and a polydispersity index, PDi, from 0.5 to 2.0; and
(C) the composition has (i) a solids content greater than or equal to 65.5 wt %. In an embodiment, the composition is void of a thickener, or otherwise excludes a thickener, and the composition (ii) has a viscosity less than 650 cps at 65.5 wt % solids content.

In an embodiment, the article is a pressure sensitive adhesive article. A “pressure sensitive adhesive article,” as used herein, is an article in which a pressure sensitive adhesive (PSA) is adhered to a first substrate, the PSA having an “available surface,” the available surface being an exposed surface, available to make contact with a second substrate. The available surface of the PSA may or may not be in contact with a release material. A “release material,” as used herein, is a material that forms a weak bond with the PSA, such that the PSA may be readily removed by hand to expose the available surface.

The article includes a first substrate. The first substrate is a film, a cellulose-based material, a fabric, a tape, or a release liner, and combinations thereof.

In an embodiment, the first substrate is a film. Nonlimiting examples of films suitable for the first substrate include plastic films (unstretched film, or uniaxially stretched film, or biaxially stretched film) such as propylene-based polymer film, ethylene-based polymer film, ethylene/propylene copolymer films, polyester films, poly(vinyl chloride) films, metallized films, foam substrates such as polyurethane foams, and polyethylene foams; and metal foils such as aluminum foils or copper foils.

In an embodiment, the first substrate is a cellulose-based material. Nonlimiting examples of cellulose-based material suitable for the substrate include paper such as craft paper, crepe paper and Japanese paper, labels, and cardboard.

In an embodiment, the first substrate is a fabric. Nonlimiting examples of fabric suitable for the substrate included cotton fabrics, staple-fiber fabrics, nonwoven fabrics such as polyester nonwoven fabrics, vinyl on nonwoven fabrics, and combinations thereof.

In an embodiment, the first substrate is a release liner. Nonlimiting examples of suitable materials for the release liner include fluorocarbon polymers (e.g., polytetrafluoroethylene, polychlorotrifluoro-ethylene, polyvinyl fluoride, polyvinylidene fluoride, a tetrafluoroetylene-hexafluoropropylene copolymer, a chlorofluoroethylene-vinylidene fluoride copolymer, etc.), siliconized paper or film, and non-polar polymers (e.g., olefin-based resins such as ethylene-based polymers and propylene-based polymers.

In an embodiment, the thickness of the first substrate (film, cellulose-based material, fabric, tape, or release liner) is from 10 microns to 10000 microns, or from 10 microns to 1000 microns, or from 20 microns to 500 microns, or from 50 microns to 100 microns, or from 100 microns to 200 microns, or from 200 microns to 500 microns.

The PSA layer is formed by applying, on one, or both, first substrate surface(s), the water-based PSA composition, followed by drying or curing. The water-based PSA composition can be any water-based PSA composition as previously disclosed herein. For the application of the PSA composition a coater, e.g., a gravure roll coater, a reverse roll coater, a kiss roll coater, a dip roll coater, a bar coater, a knife coater, a spray coater, curtain coater, slot die coater, comma coater, knife coater or the like, can be employed. In an embodiment, the surface(s) of the substrate to which the pressure-sensitive adhesive layer is applied is/are subjected to a surface treatment. Nonlimiting examples of suitable surface treatments include a primer coating, and a corona discharge treatment prior to application of the PSA layer onto the substrate surface(s).

In an embodiment, the thickness of the PSA layer on the substrate surface is from 1 micron to 500 microns, or from 10 microns to 110 microns, or from 30 microns to 90 microns, or from 1 micron to 10 microns, or from 10 microns to 50 microns.

In an embodiment, the article is a multi-layer PSA article. A “multi-layer PSA article,” as used herein, includes a substrate and two or more PSA layers such that a first PSA layer is in contact with the substrate and a second PSA layer is in contact with the first PSA layer. The multi-layer PSA article may include additional PSA layers wherein each additional PSA layer is in contact with a preceding PSA layer, the PSA layers arranged in a stacked manner. For example, the multi-layer PSA article can include a third PSA layer, the third PSA layer in contact with, and stacked upon, the second PSA layer. The multi-layer PSA article can include a fourth PSA layer, the fourth PSA layer in contact with, and stacked upon, the third PSA layer. The multi-layer PSA article can include a fifth PSA layer, the fifth PSA layer in contact with, and stacked upon, the fourth PSA layer. At least one of the PSA layers of the multi-layer PSA article is composed of any dried water-based PSA composition as previously disclosed herein.

By way of example, and not limitation, some embodiments of the present disclosure will now be described in detail in the following Examples.

### Examples

TABLE 1
Materials used in the comparative samples (CS) and inventive examples (IE)

| Material/Description | Type | Source |
|---|---|---|
| Sodium carbonate, ammonium persulfate, tert-butyl hydroperoxide, | Various | Sigma- |
| sodium formaldehyde sulfoxylate dihydrate, iso-butyl methacrylate | chemicals | Aldrich |
| (“iBMA”), methyl 3-mercaptopropionate, itaconic acid (“IA”), acetic | | |
| acid, iron (III) sulfate, tetrasodium pyrophosphate, ascorbic acid, | | |
| sodium persulfate, sodium hydroxide, sodium vinyl sulfonate (“SVS”), | | |
| sodium bisulfite | | |
| 2-ethylhexyl acrylate (“2-EHA”), ethyl acrylate (“EA”), methyl | Acrylic | Dow, Inc. |
| methacrylate (“MMA”), acrylic acid (“AA”), butyl acrylate (“BA”), | dispersion | |
| methacrylic acid (“MAA”), butyl methacrylate (“BMA”), vinyl acetate | monomers and | |
| (“VA”), styrene (“Sty”), 2-hydroxyethyl acrylate (“HEA”), DOWFAX ™ | surfactant | |
| 2A1 | | |
| Tetrasodium ethylenediaminetetraacetate | Additive | Dow, Inc. |
| Disodium ethoxylated alcohol half ester of sulfosuccinic acid, sodium | Surfactants | Solvay |
| dodecylbenezenesulfonate | | |
| Tetrasodium 1,1-diphosphonatoethanol | Additive | Italmatch |
| | | Chemicals |
| Sulfuric ester sodium salt of isoctylphenol ethoxylated by 25 moles | Surfactant | BASF |
| of ethylene oxide, Lutensol TO 6 | | |
| Sodium lauryl sulfate | Surfactant | Stepan |

### 1. Calculation of Estimated Polymer Tg

Polymers with Mn greater than 35,000 Da: The polymer Tg (Kelvin) of a copolymer with Mn greater than 35,000 Da prepared from n monomer units may be estimated using the Fox equation as follows:

$$\frac{1}{T g} = {\sum }_{i = 1}^{n} \frac{{w}_{i}}{T {g}_{i}}$$

where wᵢ is the weight fraction of the i-th monomer unit in the polymer (not including any chain transfer agent or initiator residues) and Tgᵢ is the homopolymer Tg (Kelvin) of the i-th monomer unit in the polymer.

Polymers with Mn less than or equal to 35,000 Da: The polymer Tg (Kelvin) of a copolymer with Mn less than or equal to 35,000 Da prepared from n monomer units may be estimated using the Flory-Fox equation as follows:

$$T g = T {g}_{F o x} - \frac{K}{M n}$$

where K is a constant equal to 85,000 Da, Mn is the number average molecular weight of the polymer, and Tg_{Fox} is the Tg (Kelvin) calculated using the Fox equation above.

The following “Polymer Tg” values in the Table A below may be used to calculate estimated polymer Tg values for the monomer units that are present in the first polymer and/or in the second polymer.

TABLE A

| Monomer | |
|---|---|
| unit in | Polymer |
| first/second | Tg |
| polymer | (°C) |
| BA | −54 |
| MMA | 105 |
| AA | 105 |
| IA | 154 |
| Sty | 100 |
| BMA | 20 |
| MAA | 228 |
| SVS | −27 |
| EHA | −65 |
| VA | 30 |
| iBMA | 53 |
| HEA | −14 |

### 2. Preparation of Comparative Samples

Comparative Sample 1: Polymer composition: 80(89.2 BA/7.5 MMA/1 AA/0.31A/2 STY)//20(73.6 BMA/24.5 BA/1.9 MMP)

Sodium carbonate (0.01% BOM, 0.57 g) in 25 g water was added as buffer to a 96 °C kettle charge of a water (259 g) swept with nitrogen, equipped with overhead stirring, thermometer, and a reflux condenser. This was followed by ammonium persulfate (0.217% BOM, 5.85 g) in 25 g water as initiator and a preform seed charge (100 nm starting particle size, 1.251% BOM, 32.8 g) in 82.8 g water to set the initial particle size. A monomer emulsion feed and cofeed were started. The monomer emulsion consisted of sodium carbonate (0.02% BOM, 1.4 g), itaconic acid (0.2%, 5.2 g), acrylic acid (0.8% BOM, 21.0 g), disodium ethoxylated alcohol half ester of sulfosuccinic acid at 30% strength in water (0.17%, 14.7 g), sodium dodecylbenzenesulfonate at 22.5% strength in water (0.21% BOM, 24.8 g), butyl acrylate (71.1% BOM, 1870.8 g), methyl methacrylate (6.0% BOM, 157.2 g), styrene (1.6% BOM, 41.93 g) and water (16.8% of total monomer emulsion, 423 g) and was fed for 75 minutes. The cofeed of ammonium persulfate (0.173% BOM, 4.6 g) in 66.5 g water was fed for 75 minutes. The temperature of the reaction was controlled between 88-90 °C. When 50% of the monomer emulsion feed was added an intercept of sodium dodecylbenzenesulfonate (0.235% BOM, 26.5 g) in 16 g water was added to the kettle. The high viscosity of the polymerization reaction mixture necessitated the addition of an extra 62.5 g of water at 60 minutes after the start of the monomer feed to dilute it so that agitation of the reaction mixture could be maintained. Once the addition of the monomer emulsion concluded, 40 g of water were added to the reactor, and the reaction mixture was held at temperature. After fifteen minutes the kettle was cooled to 75 °C and dilute iron sulfate (0.001% BOM, 0.03 g) and tetrasodium ethylenediaminetetraacetate (0.001% BOM, 0.03 g) in 8 g of water was added to the kettle. Subsequently a monomer emulsion feed and cofeeds were started. The monomer emulsion consisted of tetrasodium 1,1-diphosphonatoethanol at 33% strength in water (0.002%, 0.1 g), acetic acid (0.03% BOM, 0.7 g), sodium dodecylbenzenesulfonate at 22.5% strength (0.05% BOM, 5.5 g), butyl acrylate (5% BOM, 131.4 g), butyl methacrylate (15% BOM, 394.3 g), methyl 3-mercaptopropionate (0.38% BOM, 10.1 g) and water (105.8 g) for 20 minutes. One cofeed consisted of t-butylhydroperoxide at 12.6% strength in water (0.4% BOM, 85.5 g) and was fed for 50 minutes. The other cofeed consisted of sodium formaldehyde sulfoxylate dihydrate (0.24% BOM, 8.3 g) in 90 g water and was fed for 50 minutes. During the monomer emulsion feed the temperature was controlled at 74 to 76 °C. Once the monomer emulsion finished, 30 g of water were added, and the cofeeds were continued. After the end of the cofeeds, 20 g of water were added, and the batch was allowed to cool to 65 °C. The dispersion was then neutralized with ammonium hydroxide at 28% strength (17.2 g) in 24 g water. After neutralization the batch was cooled to below 35 °C and filtered through 100 mesh. The maximum reactor agitation was 450 RPM. The final solids content was 64.9%. The particle size distribution measured by method 2 had D₁₀=101.5 nm, D₅₀=362.8 nm, and D₉₀=405.5 nm such that the polydispersity index=0.84 and the ratio D₉₀/D₁₀=4.0.

Comparative sample 2: Monomer composition 80(89.2 BA/7.5 MMA/1 AA/0.31A/2 STY)//20(73.6 BMA/24.5 BA/1.9 MMP). The dispersion was made according to the process of Comparative sample 1 with the following charges substituted in place of the 100 nm preform seed charge and the intercept of sodium dodecylbenzenesulfonate: A 235 nm seed was added to the initial charge at 2.5% solids relative to monomer (65.5 g seed in 83.2 g water) and a 60 nm seed was added to the initial charge at 0.04% solids relative to monomer (1.0 g seed in 16.6 g water). No intercept charge was added. The high viscosity of the polymerization reaction mixture necessitated the addition of an extra 62.5 g of water at 60 minutes of monomer feeds and an extra 62.5 g of water at 70 minutes of monomer feeds (total 125 g) to dilute it so that agitation of the reaction mixture could be maintained. The maximum agitation for the reactor was 500 RPM. The final solids content was 64.6 wt %. The particle size distribution measured by method 2 had D₁₀=374.5 nm, D₅₀=620.7 nm, and D₉₀=666.1 nm such that the polydispersity index=0.47 and the ratio D₉₀/D₁₀=1.8.

### 3. Preparation of Inventive Examples

Inventive example 1: Monomer composition: 80(80.9 EHA/8.3 VA/8.0 MMA/2.1 Sty/0.5 AA/0.2 SVS)//20(97 IBMA/3 MMP). Using a flask equipped with a mechanical stirrer, a charge composed of 1.68 g tetrasodium pyrophosphate, 255 g of deionized water, and 0.68 g ascorbic acid is warmed to 86 °C. Next, 39 g of 6.6% concentration sodium persulfate in water is poured into the flask. Then, 26.1 g of a polymer seed with diameter 235 nm at 25% concentration in water is poured into the flask, followed by 16.3 g of a polymer seed with diameter 100 nm at 10% concentration in water. Over a span of four hours, a monomer emulsion made up of 24.5 g of 10% strength aqueous sodium hydroxide solution, 42.6 g of a 35% concentration solution of a sulfuric ester sodium salt of iso-octylphenol ethoxylated by 25 moles of ethylene oxide in water, 10.6 g of 25.0% concentration sodium vinylsulfonate solution in water, 19.2 g of a 30% strength solution of sodium lauryl sulfate in water, 68 g of water, 27.6 g of styrene, 1,079.2 g of 2-ethylhexyl acrylate, 110.4 g of vinyl acetate, 106.8 g of methyl methacrylate, and 7.2 g of acrylic acid is gradually dispensed into the flask. At the outset, the rate of addition is 1.37 g/minute for the first six minutes. The rate of addition is then raised steadily to 6.83 g/minute over the span of forty minutes. From the outset of the emulsion feed, 101.1 g of a sodium peroxodisulfate solution at 6.6% strength in water is added at a constant rate over five hours, and the reaction medium is maintained from 85 to 87 °C. After 52% of the total amount of the monomer emulsion (both first stage and second stage) has been added to the flask, 50 g of a polymer seed with diameter 60 nm at 26% concentration in water is poured into the flask.

After the completion of the above feeds, the reaction medium is cooled to 75 °C. Next, the following three mixtures are fed to the flask: 93.8 g of a solution of 11% strength sodium bisulphite in water over the span of sixty minutes, 88.8 g of a 11% concentration aqueous solution of tert-butyl hydroperoxide over the span of fifty five minutes, and a monomer emulsion of 0.8 g acetic acid, 32.5 g water, 4 g of a 22% strength solution of sodium dodecylbenzene sulfonate in water, 10.1 g of methyl 3-mercaptopropionate, and 322.7 g of iso-butyl methacrylate over the span of 15 minutes. After the completion of the monomer emulsion addition, the reaction medium is cooled to 55 °C over the course of 45 minutes.

An acrylic emulsion with a solids content of 67.0% and viscosity of 1512 cP (#3/30 RPM) is obtained. The particle size distribution (measured by method 1) had D₁₀=152.6 nm, D₅₀=515.7 nm, and D₉₀=976.2 nm such that the polydispersity index=1.60 and the ratio D₉₀/D₁₀=6.4. The maximum agitation for the reactor was 500 RPM.

Inventive example 2: Monomer composition 80(89.2 BA/7.5 MMA/1 AA/0.31A/2 STY)//20(73.6 BMA/24.5 BA/1.9 MMP). The dispersion was made according to the process of Comparative sample 1 with the following charges substituted in place of the 100 nm preform seed charge and the intercept of sodium dodecylbenzenesulfonate: A 100 nm seed at 0.3% solids relative to monomer (7.9 g seed in 19.6 g water) was added to the initial charge and a 60 nm seed intercept at 0.8% solids relative to monomer (21 g seed in 41.1 g water) was added to the reactor at 40% of the feed of the first monomer emulsion (32% of total). No extra water had to be added to the polymerization reaction mixture to maintain agitation. The maximum agitation rate in the reactor was 350 RPM. The final solid content was 66.8%. The particle size distribution measured by method 2 had D₁₀=175.3 nm, D₅₀=527.0 nm, and D₉₀=575.2 nm such that the polydispersity index=0.76 and the ratio D₉₀/D₁₀=3.3.

Inventive example 3: Monomer composition 80(89.2 BA/7.5 MMA/1 AA/0.31A/2 STY)//20(73.6 BMA/24.5 BA/1.9 MMP). The dispersion was made according to the process of Comparative sample 1 with the following charges substituted in place of the 100 nm preform seed charge and the intercept of sodium dodecylbenzenesulfonate: a 100 nm seed at 0.45% solids relative to monomer (11.8 g seed in 44.4 g water) was added to the initial charge and a 60 nm seed intercept at 1% solids relative to monomer (26.2 g seed in 47.7 g water) was added to the reactor at 40% of the feed of the first monomer emulsion (32% of total). No extra water had to be added to the polymerization reaction mixture to maintain agitation. The maximum agitation rate in the reactor was 400 RPM. The final solid content was 66.8 wt %. The particle size distribution measured by method 2 had D₁₀=161.8 nm, D₅₀=458.0 nm, and D₉₀=501.7 nm such that the polydispersity index=0.74 and the ratio D₉₀/D₁₀=3.1.

Inventive example 4: Monomer composition 80(89.2 BA/7.5 MMA/1 AA/0.31A/2 STY)//20(73.6 BMA/24.5 BA/1.9 MMP). The dispersion was made according to the process of Comparative sample 1 with the following charges substituted in place of the 100 nm preform seed charge and the intercept of sodium dodecylbenzenesulfonate: a 235 nm seed was added to the initial charge at 0.4% solids relative to monomer (10.5 g seed in 19.9 g water) and a 60 nm seed was added to the initial charge at 0.06% solids relative to monomer (1.6 g seed in 13.4 g water). At the point when 50% of the first stage monomer was fed to the reactor, a charge of 40 nm diameter seed at 0.4% solids relative to monomer (10.5 g seed in 31.3 g water) was added to the reactor. No extra water had to be added to the polymerization reaction mixture to maintain agitation. The maximum agitation rate in the reactor was 450 RPM. The final solid content was 66.8 wt %. The particle size distribution measured by method 2 had D₁₀=193.1 nm, D₅₀=535.3 nm, and D₉₀=760.6 nm such that the polydispersity index=1.06 and the ratio D₉₀/D₁₀=3.9.

Inventive example 5: Monomer composition 80(89.2 BA/7.5 MMA/1 AA/0.31A/2 STY)//20(73.6 BMA/24.5 BA/1.9 MMP). The dispersion was made according to the process of Comparative sample 1 with the following charges substituted in place of the 100 nm preform seed charge and the intercept of sodium dodecylbenzenesulfonate: a 370 nm seed was added to the initial charge at 2.0% solids relative to monomer (52.4 g seed in 51.8 g water) and a 60 nm seed was added to the initial charge at 0.06% solids relative to monomer (1.6 g seed in 13.4 g water). At the point when 50% of the first stage monomer was fed to the reactor, a charge of 40 nm diameter seed at 0.4% solids relative to monomer (10.5 g seed in 31.3 g water) was added to the reactor. No extra water had to be added to the polymerization reaction mixture to maintain agitation. The maximum agitation rate in the reactor was 400 RPM. The final solids content was 66.2 wt %. The particle size distribution measured by method 2 had D₁₀=92.9 nm, D₅₀=462.9 nm, and D₉₀=887.8 nm such that the polydispersity index=1.72 and the ratio D₉₀/D₁₀=9.6.

Inventive Example 6: Monomer composition 80(89.2 BA/7.5 MMA/1 AA/0.31A/2 STY)//20(73.6 BMA/24.5 BA/1.9 MMP). The dispersion was made according to the process of Comparative sample 1 with the following charges substituted in place of the 100 nm preform seed charge and the intercept of sodium dodecylbenzenesulfonate: a 235 nm seed was added to the initial charge at 2.0% solids relative to monomer (52.4 g seed in 74.5 g water). At the point when 25% of the first stage monomer was fed to the reactor, a charge of 100 nm seed was added at 0.6% solids relative to monomer (15.7 g seed in 30.0 g water). No extra water had to be added to the polymerization reaction mixture to maintain agitation. The maximum agitation for the reactor was 400 RPM. The final solids content was 66.4 wt %. The particle size distribution measured by method 2 had D₁₀=248.0 nm, D₅₀=645.7 nm, and D₉₀=684.9 nm such that the polydispersity index=0.68 and the ratio D₉₀/D₁₀=2.8.

Inventive Example 7: Monomer composition 90(80.7 EHA/8.0 MMA/8.3 VA/0.5 AA/0.2 SVS/2.1 STY/0.17 nDDM)//10(91 IBMA/5 MMA/4 MMP). The dispersion was made according to the process of Inventive Example 1 with the following modified charges. The initial charge contained 0.77 g ascorbic acid instead of 0.68 g ascorbic acid. The pre-polymerization persulfate charge was 39 g of 7.5% concentration sodium persulfate in water. The monomer emulsion to prepare the first polymer was made up of 5.5 g of 50% strength aqueous sodium hydroxide solution, 47.9 g of a 35% concentration solution of a sulfuric ester sodium salt of iso-octylphenol ethoxylated by 25 moles of ethylene oxide in water, 11.9 g of 25.0% concentration sodium vinylsulfonate solution in water, 21.6 g of a 30% strength solution of sodium lauryl sulfate in water, 87.5 g of water, 31.1 g STY, 1,0241.1 g EHA, 124.2 g VA, 120.2 g of MMA, 2.48 g of n-DDM, and 8.1 g AA. The monomer emulsion was fed over four hours. The initial rate of addition was 1.53 g/minute for the first six minutes. The rate of addition was then raised steadily to 7.64 g/minute over the span of forty minutes. From the outset of the emulsion feed, 152.1 g of a sodium peroxodisulfate solution at 4.9% strength in water was added at a constant rate over five hours. The monomer emulsion to prepare the second polymer was made up of 0.8 g acetic acid, 32.5 g water, 2 g of a 22% strength solution of sodium dodecylbenzene sulfonate in water, 3.92 g MMP, 8.12 g MMA, and 154.4 g IBMA.

An acrylic emulsion with a solids content of 66.2% and viscosity of 972 cP (#3/30 RPM) is obtained. The particle size distribution (measured by method 1) had D₁₀=194.4 nm, D₅₀=732.0 nm, and D₉₀=1005 nm such that the polydispersity index=1.11 and the ratio D₉₀/D₁₀=5.2. The maximum agitation for the reactor was 450 RPM.

Inventive Example 8: Monomer composition 75(80.9 EHA/6.0 MMA/8.3 VA/0.5 AA/0.2 SVS/2.1 STY/2.0 HEA/0.01 MMP)//25(61.9 BMA/22 IBMA/12.5 BA/1.5 MMA/0.5 STY/0.5 MAA/1.3 MMP). The dispersion was made according to the process of Inventive Example 1 with the following modified charges. The initial charge contained 0.64 g ascorbic acid instead of 0.68 g ascorbic acid. The pre-polymerization persulfate charge was 39 g of 6.2% concentration sodium persulfate in water. In place of the 235 nm seed and 100 nm seed charges was substituted a charge of 56.3 g of only a 235 nm preform seed charge at 26.5% concentration in water. The monomer emulsion to prepare the first polymer was made up of 4.6 g of 50% strength aqueous sodium hydroxide solution, 33.8 g of a 33% concentration solution of a sulfuric ester sodium salt of lauryl alcohol ethoxylated by 30 moles of ethylene oxide in water, 9.9 g of 25.0% concentration sodium vinylsulfonate solution in water, 5.63 g of DOWFAX™ 2A1, 2.1 g of Lutensol TO 6, 87.5 g of water, 25.9 g STY, 1,011.8 g EHA, 103.5 g VA, 75.1 g of MMA, 24.8 g HEA, and 6.8 g AA.

The monomer emulsion was fed over four hours. The initial rate of addition was 1.29 g/minute for the first six minutes. The rate of addition was then raised steadily to 6.44 g/minute over the span of forty minutes. At the point when 60% of the first stage monomer was fed to the reactor, a charge of 0.124 g of MMP was mixed into to the monomer emulsion. From the outset of the emulsion feed, 101.1 g of a sodium peroxodisulfate solution at 6.2% strength in water was added at a constant rate over five hours. The monomer emulsion to prepare the second polymer was made up of 2.05 g methacrylic acid, 32.5 g water, 5 g of a 22% strength solution of sodium dodecylbenzene sulfonate in water, 5.55 g MMP, 6.16 g MMA, 2.05 g STY, 51.3 g BA, 257.4 g BMA, and 91.5 g IBMA.

An acrylic emulsion with a solids content of 67.6% and viscosity of 2788 cP (#3/30 RPM) is obtained. The particle size distribution (measured by method 1) had D₁₀=222.8 nm, D₅₀=850.9 nm, and D₉₀=1305 nm such that the polydispersity index=1.27 and the ratio D₉₀/D₁₀=5.9. The maximum agitation for the reactor was 425 RPM. The final solids content was 67.6 wt %.

Table 2 below summarizes the properties for comparative samples (CS 1-2) and inventive examples (IE 1-8) where component amounts are shown as weight percent based on dry weight of the pressure-sensitive adhesive composition. The dispersions which were made at greater than 65.5% solids were diluted with water to 65.5% in order to measure their viscosity at a normalized solids level.

TABLE 2
water-based pressure-sensitive adhesive compositions and properties

| | Composition, estimated | Composition, estimated | Final | Solids | Viscosity at | Viscosity at | | | | | |
|---|---|---|---|---|---|---|---|---|---|---|---|
| | Tg, and molecular weight | Tg, and molecular weight | product | as made | solids as | 65.5% solids | D₁₀ | D₅₀ | D₉₀ | | D₉₀/ |
| | 1st polymer | 2nd polymer | Tg (°C) | (%) | made (cP) | (cP) | (nm) | (nm) | (nm) | PDi | D₁₀ |
| CS1 | 89.2 BA/7.5 MMA/ | 73.6 BMA/24.5 BA/ | | 64.9 | 1024 | n/a | 101.5 | 362.8 | 405.5 | 0.84 | 4.0 |
| | 1 AA/0.31A/2 STY | 1.9 MMP | | | | | | | | | |
| | Tg = −43.6 °C | Tg = −21.7 °C | | | | | | | | | |
| | Mn = 108,000, | Mn = 4500, | | | | | | | | | |
| | Mw = 488,000 | Mw = 7600 | | | | | | | | | |
| CS2 | 89.2 BA/7.5 MMA/ | 73.6 BMA/24.5 BA/ | −37.2 | 64.6 | 680 | n/a | 374.5 | 620.7 | 666.1 | 0.47 | 1.8 |
| | 1 AA/0.31A/2 STY | 1.9 MMP | | | | | | | | | |
| | Mn = 145,600, | Mn = 7,000, | | | | | | | | | |
| | Mw = 343,000 | Mw = 12,900 | | | | | | | | | |
| | Tg = −43.6 °C | Tg = −14.9 °C | | | | | | | | | |
| IE1 | 0.2 SVS/2.1 STY/ | 97 iBMA/3 MMP | −45.7 | 67.0 | | 612 | 152.6 | 515.7 | 976.2 | 1.60 | 6.4 |
| | 80.9 2EHA/8.3 VA/ | Mn = 4500, | | | | | | | | | |
| | 8.0 MMA/0.5 AA | Mw = 7600 | | | | | | | | | |
| | Mn = 110,000, | Tg = 34.1 °C | | | | | | | | | |
| | Mw = 490,000 | | | | | | | | | | |
| | Tg = −48.4 °C | | | | | | | | | | |
| IE2 | 89.2 BA/7.5 MMA/ | 73.6 BMA/24.5 BA/ | −34.8 | 66.8 | | 268 | 175.3 | 527.0 | 575.2 | 0.76 | 3.3 |
| | 1 AA/0.31A/2 STY | 1.9 MMP | | | | | | | | | |
| | Mn = 100,000, | Mn = 5100, | | | | | | | | | |
| | Mw = 610,000 | Mw = 8200 | | | | | | | | | |
| | Tg = −43.6 °C | Tg = −19.5 °C | | | | | | | | | |
| IE3 | 89.2 BA/7.5 MMA/ | 73.6 BMA/24.5 BA/ | −35.6 | 66.8 | | 324 | 161.8 | 458.0 | 501.7 | 0.74 | 3.1 |
| | 1 AA/0.31A/2 STY | 1.9 MMP | | | | | | | | | |
| | Mn = 146,700, | Mn = 6,600, | | | | | | | | | |
| | Mw = 345,500 | Mw = 12,700 | | | | | | | | | |
| | Tg = −43.6 °C. | Tg = −15.7 °C | | | | | | | | | |
| IE4 | 89.2 BA/7.5 MMA/ | 73.6 BMA/24.5 BA/ | −35.3 | 66.8 | | 296 | 193.1 | 535.3 | 760.6 | 1.06 | 3.9 |
| | 1 AA/0.31A/2 STY | 1.9 MMP | | | | | | | | | |
| | Mn = 143,000, | Mn = 6,400, | | | | | | | | | |
| | Mw = 346,000 | Mw = 12,000 | | | | | | | | | |
| | Tg = −43.6 °C | Tg = −16.1 °C | | | | | | | | | |
| IE5 | 89.2 BA/7.5 MMA/ | 73.6 BMA/24.5 BA/ | −34.9 | 66.2 | | 248 | 92.9 | 462.9 | 887.8 | 1.72 | 9.6 |
| | 1 AA/0.31A/2 STY | 1.9 MMP | | | | | | | | | |
| | Mn = 150,000, | Mn = 6,600, | | | | | | | | | |
| | Mw = 361,000 | Mw = 12,200 | | | | | | | | | |
| | Tg = −43.6 °C | Tg = −15.7 °C | | | | | | | | | |
| IE6 | 89.2 BA/7.5 MMA/ | 73.6 BMA/24.5 BA/ | −34.7 | 66.4 | | 260 | 248 | 645.7 | 684.9 | 0.68 | 2.8 |
| | 1 AA/0.3IA/2 STY | 1.9 MMP | | | | | | | | | |
| | Mn = 143,500, | Mn = 6,650, | | | | | | | | | |
| | Mw = 336,900 | Mw = 12,650 | | | | | | | | | |
| | Tg = −43.6 °C | Tg = −15.6 °C | | | | | | | | | |
| IE7 | 80.7 EHA/8.0 MMA/ | 91 IBMA/5 MMA/ | −47.6 | 66.2 | | 632 | 194.4 | 732.0 | 1005 | 1.11 | 5.2 |
| | 8.3 VA/0.5 AA/0.2 SVS/ | 4 MMP | | | | | | | | | |
| | 2.1 STY/0.17 nDDM | Mn = 3,100, | | | | | | | | | |
| | Mn = 56,500, | Mw = 5,500 | | | | | | | | | |
| | Mw = 141,400 | Tg = −3.9 | | | | | | | | | |
| | Tg = −48.4 | | | | | | | | | | |
| IE8 | 80.9 EHA/6.0 MMA/ | 61.9 BMA/22 IBMA/ | −51.0 | 67.6 | | 560 | 222.8 | 850.9 | 1305 | 1.27 | 5.9 |
| | 8.3 VA/0.5 AA/ | 12.5 BA/1.5 MMA/ | | | | | | | | | |
| | 0.2 SVS/2.1 STY/ | 0.5 STY/0.5 MAA/ | | | | | | | | | |
| | 2.0 HEA/0.01 MMP | 1.3 MMP | | | | | | | | | |
| | Mn = 152,700, | Mn = 7,600, | | | | | | | | | |
| | Mw = 252,400 | Mw = 18,800 | | | | | | | | | |
| | Tg = −49.6 | Tg = 5.0 | | | | | | | | | |

All other factors being equal, the viscosity of a waterborne dispersion generally increases with increasing solids content, particularly at greater than 65 wt % solids content. It is known to blend (i) high molecular weight, low Tg pressure sensitive adhesive polymer dispersions and (ii) low molecular weight, high Tg tackifier dispersions to lower solids content for the final dispersion. It is further known that the viscosity of a waterborne dispersion can be decreased by creating a bimodal particle size distribution (two different modes of particle sizes). CS1 and CS2 and IE1-IE8 each is composed of both (i) a high molecular weight, low Tg pressure sensitive adhesive polymer and (ii) a low molecular weight, high Tg tackifier polymer, and (iii) each has a bimodal particle size distribution. However, the ability of IE1 to IE8 to exhibit (i) a low viscosity (less than 650 cP) (ii) at higher solids content (65.5 wt %) compared to CS1/CS2 that are unable to achieve a viscosity less than 650 cP even at a 65 wt % solids content (respective solids content 64.9 wt %, 64.6 wt %) is counter-intuitive and is unexpected.

### Preparation of PSA Article

Samples of the water-based PSA composition were directly coated onto a polyethylene terephthalate (“PET”) film (60 microns in thickness) and dried at 80 °C for 5 minutes to achieve a dried coat weight of 19 to 20 grams per square meter. A siliconized release paper was laminated with the water-based pressure-sensitive adhesive coated film to prepare the “adhesive laminate.”

Performance testing was conducted after the adhesive laminate was conditioned in a controlled environment (22.2 to 23.3 °C (72 to 74 °F), 50% relative humidity) for at least 1 day (24 hours) under a 12 kg weight.

High density polyethylene (HDPE) panels purchased from Cheminstruments (510 Commercial Dr., West Chester Township, OH 45014) are cleaned and conditioned prior to being used for adhesive testing. Panels are wiped with lint-free, non-abrasive cloth soaked in isopropanol to remove any adhesive residue from prior testing. Care is taken not to scratch the surface. Once panel surface appears clean, an additional wipe is performed using isopropanol. The HDPE panel is conditioned for a minimum of 4 hours but no more than 24 hours at 22.2 to 23.3 °C (72 to 74 °F), 50% relative humidity.

### 4. PSA Application Tests

Performance testing was conducted after the water-based PSA composition in the adhesive laminate was completely dried and conditioned in a controlled environment (22.2 to 23.32 °C, 50% relative humidity) testing laboratory.

The composition of select dried PSA's are provided in Table 3. The peel adhesion, loop tack, and shear data for adhesive laminates with the dried PSA are provided in Table 3.

Table 3: Peel adhesion, loop tack, and shear data for adhesive laminates with dried PSA compositions.

TABLE 3

| | 90° Peel | 90° Peel | 90° Peel, | 90° Peel | | | |
|---|---|---|---|---|---|---|---|
| | HDPE, N/ | HDPE, N/ | SS, N/ | SS, N/ | Loop Tack | Loop Tack | |
| | 2.54 cm, | 2.54 cm, | 2.54 cm, | 2.54 cm, | HDPE, N/ | SS, N/ | Shear, |
| | 20 min | 24 hr | 20 min | 24 hr | 6.45 cm² | 6.45 cm² | SS, h |
| IE1 | 1.1 AF | 1.6 AF | 4.5 AF | 7.7 AF | 2.0 | 2.6 | 39 CF |
| IE3 | 3.6 AF | 3.7 AF | 7.3 AF | 9.9 AF | 6.8 | 9.7 | 7 CF |

AF-adhesive failure, CF-cohesive failure, IE-inventive example

It is specifically intended that the present disclosure not be limited to the embodiments and illustrations contained herein, but include modified forms of those embodiments including portions of the embodiments and combinations of elements of different embodiments as come within the scope of the following claims.

1-15. (canceled)

16. A water-based pressure-sensitive adhesive composition comprising:
a plurality of particles having a polymodal particle size distribution, the particles comprising
(A) a first acrylic-based polymer having a Tg from −80 °C to −30 °C and comprising
(i) two or more acrylic-based monomers selected from the group consisting of acrylic acid (AA), methacrylic acid (MAA), butyl acrylate (BA), 2-ethylhexyl acrylate (2-EHA), ethyl acrylate (EA), methyl methacrylate (MMA), lauryl methacrylate (LMA), octyl acrylate, isooctyl acrylate, decyl acrylate, isodecyl acrylate, lauryl acrylate, octyl methacrylate, isooctyl methacrylate, decyl methacrylate, isodecyl methacrylate and combinations thereof, and
(ii) one or more other unsaturated monomers selected from the group consisting of vinyl aromatic monomers, hydroxy-C₂-C₄ alkyl esters of monoethylenically unsaturated C₃-C₈ monocarboxylic acids, and combinations thereof;
(B) a second acrylic-based polymer different than the first acrylic-based polymer, the second acrylic-based polymer having a Tg from −20 °C to 50 °C and comprising
(i) two or more acrylic-based monomers selected from the group consisting of acrylic acid (AA), butyl acrylate (BA), ethylhexyl acrylate (2-EHA), methyl methacrylate (MMA), isobutyl methacrylate, n-butyl methacrylate (BMA), methacrylic acid (MAA), and combinations thereof, and
(ii) optionally, one or more other unsaturated monomers selected from the group consisting of vinyl aromatic monomers.

17. The water-based pressure-sensitive adhesive composition of claim 16 wherein the two or more acrylic-based monomers (A)(i) are selected from the group consisting of acrylic acid (AA), methacrylic acid (MAA), butyl acrylate (BA), 2-ethylhexyl acrylate (2-EHA), ethyl acrylate (EA), methyl methacrylate (MMA), lauryl methacrylate (LMA), and combinations thereof.

18. The water-based pressure-sensitive adhesive composition of claim 16 wherein the two or more acrylic-based monomers (A)(i) are selected from the group consisting of 2-ethylhexyl acrylate (2-EHA), octyl acrylate, isooctyl acrylate, decyl acrylate, isodecyl acrylate, and combinations thereof.

19. The water-based pressure-sensitive adhesive composition of claim 16 wherein the one or more other unsaturated monomers (A)(ii) are selected from the group consisting of styrene, 2-hydroxyethyl acrylate (HEA), 2-hydroxyethyl methacrylate (HEMA), 2-hydroxypropyl acrylate (HPA), 2-hydroxypropyl methacrylate (HPMA), and combinations thereof.

20. The water-based pressure-sensitive adhesive composition of claim 16 wherein the one or more other unsaturated monomers (A)(ii) is styrene and one or more hydroxy-C₂-C₄ alkyl esters of monoethylenically unsaturated C₃-C₈ monocarboxylic acid selected from the group consisting of 2-hydroxyethyl acrylate (HEA), 2-hydroxyethyl methacrylate (HEMA), 2-hydroxypropyl acrylate (HPA), 2-hydroxypropyl methacrylate (HPMA), and combinations thereof.

21. The water-based pressure-sensitive adhesive composition of claim 16 wherein the two or more acrylic-based monomers (B)(i) are selected from the group consisting of acrylic acid (AA), methacrylic acid (MAA), methyl methacrylate (MMA), butyl acrylate (BA), isobutyl methacrylate (IBMA), n-butyl methacrylate (BMA), and combinations thereof.

22. The water-based pressure-sensitive adhesive composition of claim 16 wherein the one or more other unsaturated monomer (B)(ii) is present and is styrene.

23. The water-based pressure-sensitive adhesive composition of claim 16 wherein the second acrylic-based polymer comprises a molecular regulator possessing a thiol group selected from the group consisting of tert-butyl mercaptan, mercaptoethanol, thioglycolic acid, thioglycolic acid ethyl ester, mercaptopropyltrimethoxysilane, tert-dodecyl mercaptan, n-dodecyl mercaptan (n-DDM), 3-mercaptopropionic acid, methyl 3-mercaptopropionate (MMP), butyl 3-mercaptopropionate, and combinations thereof.

24. The water-based pressure-sensitive adhesive composition of claim 16 wherein
(A) the first acrylic-based polymer comprises
(i) the two or more acrylic-based monomers are selected from the group consisting of acrylic acid (AA), methacrylic acid (MAA), butyl acrylate (BA), 2-ethylhexyl acrylate (2-EHA), ethyl acrylate (EA), methyl methacrylate (MMA), lauryl methacrylate (LMA), and combinations thereof,
(ii) the one or more other unsaturated monomers are selected from the group consisting of styrene and one or more hydroxy-C₂-C₄ alkyl esters of monoethylenically unsaturated C₃-C₈ monocarboxylic acid selected from the group consisting of 2-hydroxyethyl acrylate (HEA), 2-hydroxyethyl methacrylate (HEMA), 2-hydroxypropyl acrylate (HPA), 2-hydroxypropyl methacrylate (HPMA), and combinations thereof;
(B) the second acrylic-based polymer comprises
(i) two or more acrylic-based monomers selected from the group consisting of acrylic acid (AA), methacrylic acid (MAA), methyl methacrylate (MMA), butyl acrylate (BA), isobutyl methacrylate (IBMA), n-butyl methacrylate (BMA), and combinations thereof.

25. The water-based pressure-sensitive adhesive composition of claim 24 wherein the second acrylic-based polymer comprises a molecular regulator possessing a thiol group selected from the group consisting of tert-butyl mercaptan, mercaptoethanol, thioglycolic acid, thioglycolic acid ethyl ester, mercaptopropyltrimethoxysilane, tert-dodecyl mercaptan, n-dodecyl mercaptan (n-DDM), 3-mercaptopropionic acid, methyl 3-mercaptopropionate (MMP), butyl 3-mercaptopropionate; and combinations thereof.

26. The water-based pressure-sensitive adhesive composition of claim 25 wherein the one or more other unsaturated monomer (B)(ii) is present and is styrene.

27. The water-based pressure-sensitive adhesive composition of claim 16 wherein the weight of the first acrylic-based polymer (A) to the weight of the second acrylic-polymer (B) is from 92:8 to 70:30, wherein weight is based on the sum weights of the monomers in each respective acrylic-based polymer.

28. The water-based pressure-sensitive adhesive composition of claim 16 wherein
the first acrylic-based polymer (A) has a number average molecular weight, Mn, from 50,000 daltons to 5,000,000 daltons; and
the second acrylic-based polymer (B) has a number average molecular weight, Mn, from 1,000 daltons to 35,000 daltons.

29. The water-based pressure-sensitive adhesive composition of claim 16 wherein the water-based pressure-sensitive adhesive composition of claim 1 is void of vinyl acetate.

30. The water-based pressure-sensitive adhesive composition of claim 16 wherein the water-based pressure-sensitive adhesive composition of claim 1 is void of a tackifier which is different than the first polymer and the second polymer.

31. The water-based pressure-sensitive adhesive composition of claim 1 wherein
the particles have
a d₅₀ greater than 450 nm, and
a polydispersity index, PDi, from 0.5 to 2.0.

32. An article comprising:
a first substrate; and
a layer of a dried water-based pressure-sensitive adhesive composition on the first substrate, the dried water-based pressure-sensitive adhesive composition comprising
a plurality of particles having a polymodal particle size distribution, the particles comprising
(A) a first acrylic-based polymer having a Tg from −80 °C to −30 °C and comprising
(i) two or more acrylic-based monomers selected from the group consisting of acrylic acid (AA), methacrylic acid (MAA), butyl acrylate (BA), 2-ethylhexyl acrylate (2-EHA), ethyl acrylate (EA), methyl methacrylate (MMA), lauryl methacrylate (LMA), octyl acrylate, isooctyl acrylate, decyl acrylate, isodecyl acrylate, lauryl acrylate, octyl methacrylate, isooctyl methacrylate, decyl methacrylate, isodecyl methacrylate and combinations thereof, and
(ii) one or more other unsaturated monomers selected from the group consisting of vinyl aromatic monomers, hydroxy-C₂-C₄ alkyl esters of monoethylenically unsaturated C₃-C₈ monocarboxylic acids, and combinations thereof;
(B) a second acrylic-based polymer different than the first acrylic-based polymer, the second acrylic-based polymer having a Tg from −20 °C to 50 °C and comprising
(i) two or more acrylic-based monomers selected from the group consisting of acrylic acid (AA), butyl acrylate (BA), ethylhexyl acrylate (2-EHA), methyl methacrylate (MMA), isobutyl methacrylate, n-butyl methacrylate (BMA), methacrylic acid (MAA), and combinations thereof, and
(ii) optionally, one or more other unsaturated monomers selected from the group consisting of vinyl aromatic monomers.

33. The article of claim 32 wherein the first substrate is selected from the group consisting of a cellulose-based material, a fabric, a tape, a release liner, and combinations thereof.

34. The article of claim 32 wherein the first substrate is selected from the group consisting of craft paper, crepe paper, Japanese paper, labels, and cardboard.

35. The article of claim 32 wherein the first substrate is a film.
